(19) United States
(12) Patent Application Publication
(10) Pub. No.: US 2006/0227140 A1
(43) Pub. Date: Oct. 12, 2006

(54) Sketch beautification

(76) Inventors: Karthik Ramani, West Lafayette, IN (US); Jiantao Pu, Mountain View, CA (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/385,459

(22) Filed: Mar. 21, 2006

Related U.S. Application Data
(60) Provisional application No. 60/664,005, filed on Mar. 21, 2005.

(51) Int. Cl. G06T 11/20

(52) U.S. Cl. 345/441

(57) ABSTRACT

There are disclosed methods to provide methods for beautifying sketches. Methods are disclosed for determining segments of drawings that represent geometric primitives and implied geometric constraints. Beautification methods provide for replacement of sketched primitives and over- and under-sketched drawings. After beautification methods provide for checking the initial segmentation of the sketch to determine whether false segmentation points were identified. Methods are also disclosed to provide for searching of drawings based upon a beautified sketch. User interactivity is provided to further refine search results.

### CROSS REFERENCE TO RELATED APPLICATIONS

The present application claims the benefit of U.S. Provisional Patent Application Ser. No. 60/664,005, filed Mar. 21, 2005, with said priority application being incorporated herein by reference in its entirety. This application is also related to U.S. patent application Ser. No. 11/288,911, filed Nov. 29, 2005, entitled: METHODS FOR RETRIEVING SHAPES AND DRAWINGS (Inventors: Karthik Ramani and Jiantao Pu), which is hereby incorporated by reference in its entirety. This application is also related to “Toward Freehand Sketch Beautification Driven by Geometric Constraint” by Pu Jiantao and Karthik Ramani which is hereby incorporated by reference in its entirety.

### BACKGROUND

As an efficient and natural way to communicate ideas, the potential advantages of freehand sketch have been widely recognized and exploited in many fields. One phenomenon is that the pen is becoming a standard interaction tool in most computing devices such as tablet PCs, electronic whiteboards, and personal digital assistants (PDAs). Despite great efforts made since Sutherland's Sketchpad in 1963, the correct interpretation of sketches can still be a difficult problem. The difficulty arises from the fact that freehand sketches are informal, ambiguous, and implicit compared to the traditional WIMP (Window, Icon, Menu, and Pointer) user interfaces. Even the sketches representing the same semantics will vary greatly when drawn by the same user at different times.

### BRIEF DESCRIPTION OF THE DRAWINGS

Although the characteristic features of this invention will be particularly pointed out in the claims, the invention itself, and the manner in which it may be made and used, may be better understood by referring to the following description taken in connection with the accompanying figures forming a part thereof.

FIG. 1 is a schematic representation of an embodiment of a sketch beautification system.

FIG. 2 are representations of a sketch having explicit geometric constraints and a beautified drawing conforming to the constraints.

FIG. 3 shows the relative orientation of bounding boxes and squares as well as locations for scanning circles.

FIG. 4 shows a sketch, scanning circles and intersection points.

FIG. 5 shows a comparison of segment points using scanning circles located at different positions.

FIG. 6 shows sketching track distribution and directions.

FIG. 7 shows intersection points of scanning circles and sketches.

FIG. 8 shows example sketches with varying complexity.

FIG. 9 shows the relationship between the ratio of detected segment points to expected segment points versus the step size of a scanning circle.

FIG. 10 shows an example of scanning circles detecting multiple segment points.

FIG. 11 shows an example of a falsely detected segment point.

FIG. 12 shows examples of sketched primitives.

FIG. 13 shows representative shape histograms of selected geometric primitives.

FIG. 14 shows similarity graphs for a variety of shapes.

FIG. 15 shows a variety of shapes intermediate of a line and a circle.

FIG. 16 shows a variety of symbols used in the evaluation of composite sketch recognition.

FIG. 17 shows the progression from a sketch to a beautified result.

FIG. 18 shows an example of merging neighboring arcs.

FIG. 19 shows examples of relative shape histograms.

FIG. 20 S shows the difference between Minkowski distance and dynamic time warping.

FIG. 21 shows an example of implied constraints before and after beautification.

FIG. 22 shows beautification driven by geometric constraints.

FIG. 23 shows a primitive with line drawn between start and end points.

FIG. 24 shows an approach to determining proper segment points.

FIG. 25 shows an example of possibilities in detected dₘₐₓ.

FIG. 26 shows an approach to determining proper segment points.

FIG. 27 shows an approach to determining proper segment points.

FIG. 28 shows examples of regularizing user sketches.

### DETAILED DESCRIPTION

For the purposes of promoting an understanding of the principles of the disclosure, reference will now be made to the embodiments illustrated in the drawings and specific language will be used to describe the same. It will nevertheless be understood that no limitation of the scope of the claims is thereby intended, and alterations and modifications in the illustrated devices, and further applications of the principles of the disclosure as illustrated therein are herein contemplated as would normally occur to one skilled in the art to which the disclosure relates.

The techniques and methods disclosed herein are, generally speaking, aimed at providing ways to effectively and efficiently beautify hand sketches for a variety of purposes including, but not limited to, searching databases for similar drawings. In these methods, particular emphasis is placed on segmenting sketches, identifying geometric primitives in the segmented sketches, identifying implicit geometric constraints between geometric primitives, beautifying the drawings by replacing the segmented sketch with geometric primitives, and using the beautified drawings as input drawings for searching databases.

Sketch beautification can be thought of in some aspects as resolving two issues: sketch segmentation and primitive (or composite) recognition. Sketch segmentation parses the continuous stream of pen strokes into a series of constituent primitives. A robust and efficient segmentation algorithm can be used for a computer to correctly understand a user's interaction intent as the basis of higher-level symbolic and structural analysis. Primitive or composite recognition determines the kind of geometric entity a primitive or composite represents. In some applications, line, circle, and arc are the most popular primitives that constitute user's sketches, while composites can be some predefined entities, including symbols, which are composed of multiple primitives. It may be difficult in some applications for users to sketch high-order curves; but high-order curves may seldom occur in practice.

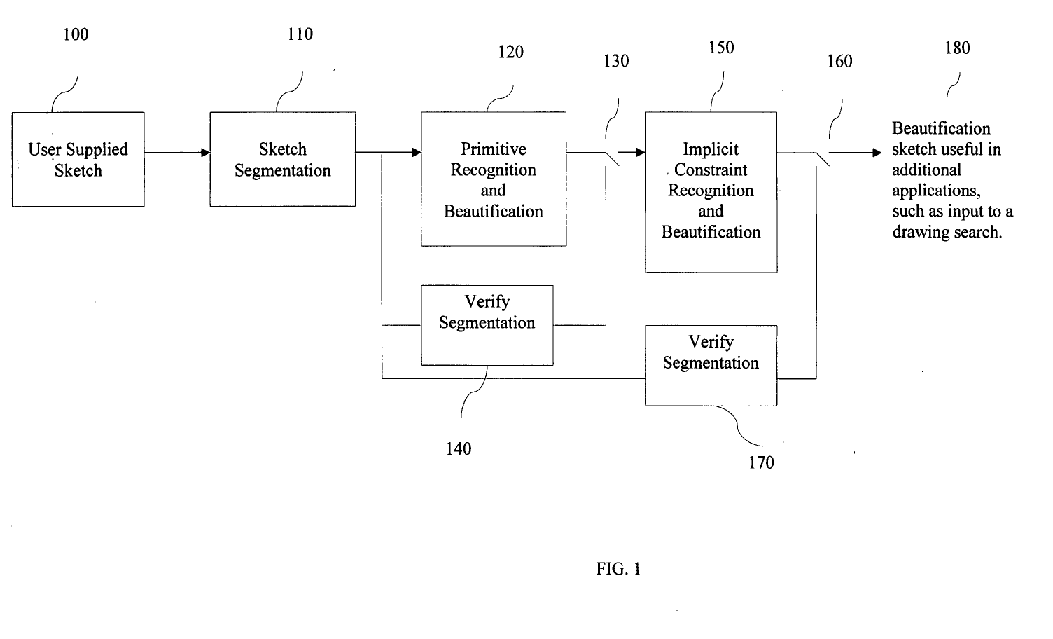

Once the primitives are recognized, freehand sketches can be beautified by assigning replacement primitives with proper parameters. Besides sketch beautification and composite (or primitive) recognition, the geometric constraints implied in sketches can also considered. Use of implied geometric constraints, as well as express geometric constraints, may also facilitate the sketch beautification process. Sketch beautification based on geometric constraints is useful in many fields. For example, in the conceptual design stage, a designer may check whether his/her initial design satisfies certain conditions. Also, the design results of the conceptual stage can be reused seamlessly in the later detailed design stage. The process described above can be illustrated by FIG. 1.

Methods are presented below to parse and recognize sketches. In some embodiments, methods presented herein may contain three components: freehand sketch segmentation, primitive (or composite) recognition, and implicit constraint detection. The segmentation procedure may be independent of the sketching speed and curvature. Also, the shape-based sketch recognition may be independent of stroke-order, -number, and -direction, as well as invariant to rotation, scaling, and translation of strokes. With the help of implicit constraint detection, the beautification may be driven by a constraint solver.

Methods disclosed below can be used to parameterize freehand sketches, allowing designers to sketch freehand drawings and regularize them in real time according to the imposed geometric constraints. In some embodiments, methods can be composed of three parts: sketch recognition, implicit constraint recognition, and regularization under geometric constraint satisfaction. Since freehand sketches can sometimes be imprecise and vary greatly even when done by the same person at different times, it may be necessary to recognize what kind of meaningful geometric primitive a sketch represents. Furthermore, during the sketching process, it may be tedious for designers to express every constraint explicitly and in many cases certain constraints may be ignored naturally as default, such as the perpendicular or parallel constraints. What is needed is a method to find constraints to ensure there is a solution for the constraint satisfaction problem. Finally, the geometric constraint system can be solved and the sketches rendered.

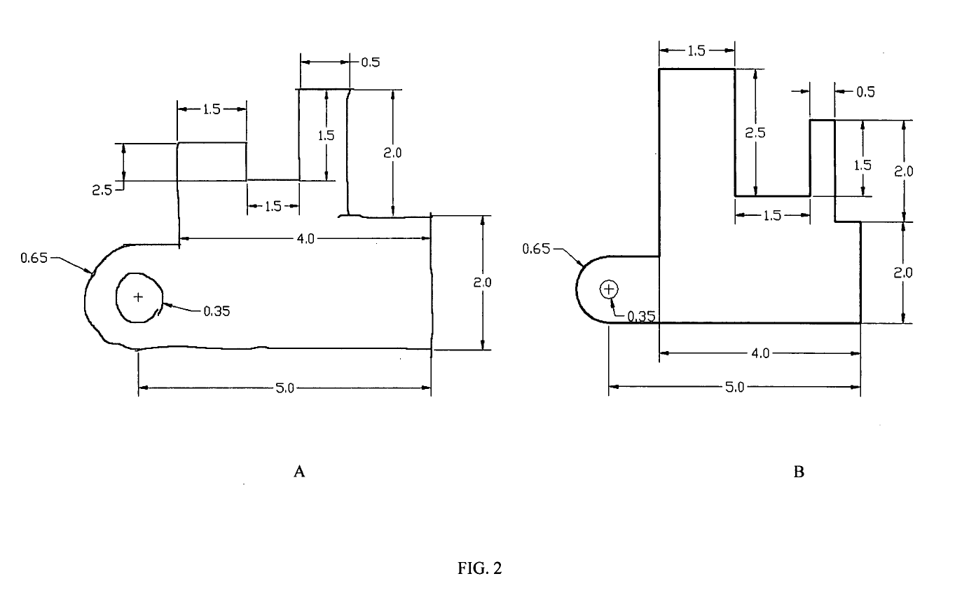

FIG. 2 shows an example of sketch beautification driven by geometric constraints, in which both explicit and implicit constraints may be considered. The term “explicit constraints” refers to constraints that a user specifies explicitly such as dimensions, while implicit constraints are those that are implied in the sketches, such as parallelism and perpendicularity. With implicit constraints, a user may express his/her ideas naturally and the efficiency will be improved by constraint recognition. It can be seen that the detection of the implicit constraint plays an important role in this process.

FIG. 2(a) is a freehand sketching design with geometric constraints; and FIG. 2(b) is the beautified result that satisfies these constraints. This situation implies a twofold motivation: on the one hand, designers would like to use freehand sketches to express their design ideas naturally; on the other hand, designers also want to know the exact representation of raw sketches that satisfy certain constraints so that the drawbacks related to the design can be found during the sketching process. Constraint based sketching can provide designers more flexibility than traditional interaction paradigms. In addition, the conceptual design results can be reused in the later detailed design stage.

The techniques presented herein enable users to beautify sketches to create drawings useful in a range of applications, some of which include further using the beautified sketches in database searching.

Segmentation Identification

Freehand sketches are usually composed of a series of basic geometric entities such as lines, circles, and arcs. When a user transmits his/her ideas using a pen, it may not be reasonable to require that each stroke only represents a single geometric primitive. On the contrary, a stroke may consist of multiple line segments and arcs. To recognize the sketches, a segmentation process can be used to parse and recognize primitive shapes from a user's stroke streams. Alternatively, an assumption can be made that a freehand stroke represents a primitive shape. Generally, sketches can be drawn offline or online. In the offline case, the sketches consist of bitmap-like pixels. In contrast with the offline sketches, during the online sketching process, the track of a stroke S can usually be composed of a sequence of small line segments rather than image bitmaps:
S={((xᵢ,yᵢ),(xᵢ₊₁,yᵢ₊₁),tᵢ)|0≦i≦n} (1)
where n is the total number of line segments included in a single stroke S, (xᵢ,yᵢ) and (xᵢ₊₁,yᵢ₊₁) are the two ending points of a small line segment at time tᵢ. Correspondingly, a sketching activity A is usually formed by a sequence of strokes:
A={Sᵢ|0≦i<m} (2)
where m is the number of strokes. In some embodiments, the sketch segmentation (ink parsing) can be described as finding all segment points that parse the stroke stream into a sequence of geometric primitives such as lines, circles, and arcs. One purpose of the geometric track is to provide the neighborhood information among consecutive intersected points between a circle and sketches. The methods disclosed herein can be extended to handle the off-line sketches if the consecutive points of the off-line sketches are tracked.

To parse a stroke into independent primitives a circle-scanning strategy can be used in which multiple circles are used to scan the sketch by changing their radii progressively. When two consecutive intersected points between a scanning circle and the sketch are close enough, the shared point between the two intersected line segments can be regarded as a segment point.

Given a stream of sketches (as Figure C(a) shows), an axes-aligned bounding box (AABB) B is determined according to Equation (3).
B={left=min{xᵢ},top=min{yᵢ},right=max{xᵢ},bottom=max{yᵢ}} (3)
where {xᵢ,yᵢ} represents the ending points of the line segments contained in this stroke. This bounding box can be used as a rough reference to determine the scanning circles and their parameters as described later. On the basis of this bounding box, a bounding square Q can be determined. This bounding square has the same center as the bounding box B, and its side length is equal to the longer length of the bounding box B.

To assure that a number of segment points can be detected, nine circles can be located at certain positions to scan the sketches. As Figure C(b) shows, Circle 1 is located at the center of the bounding box B, Circle 2-Circle 5 are located at the corners of the bounding box B obtained in Step 1, and Circle 6-Circle 9 are located at the corners of the bounding square Q. As for the radius of each circle, the radius of Circle 1 is equal to the half diagonal length of the bounding box B; the radius of Circle 2-Circle 9 is equal to the diagonal length of the bounding box B.

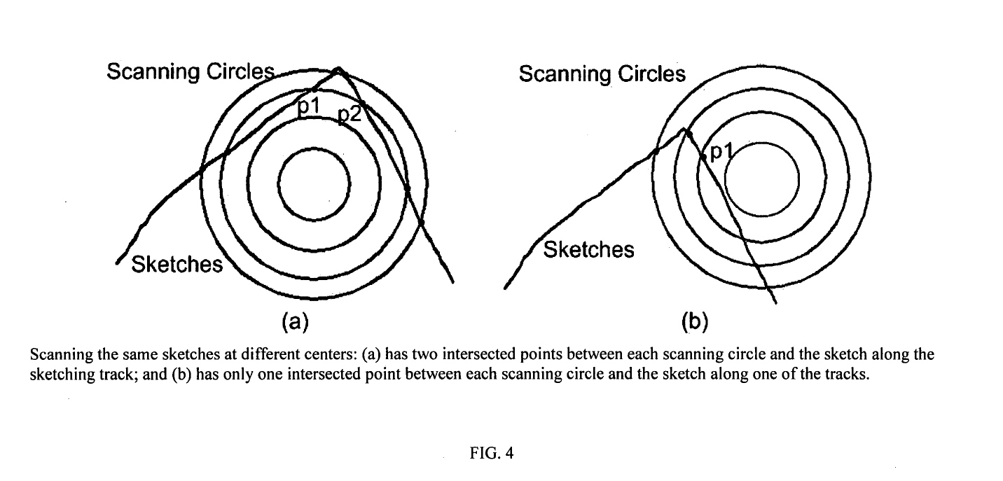

In FIG. 4, an example is shown to illustrate the difference when two scanning circles are located at two different positions. When the circle located at the position as shown in FIG. 4(a) is scanning the sketch, two consecutive intersection points, p1 and p2, are created. The expanding direction of the scanning circles is roughly perpendicular to the sketching track. When the distance between two consecutive interested points along the sketch is small enough, the middle point between the two intersected points can be regarded as the candidate segment point. However, when the circle is located at the position as shown in FIG. 4(b) scanning the sketch, there may be only one intersection point along one of the tracks. In some applications, the expanding direction of the scanning circle is along the sketching track. Since a segment point can only occur within two consecutive intersection points, there will be no segment point detected in the case D(b). From the two examples, it can be concluded that the position of a scanning circle plays an important role in the detection of the segment points. Therefore, some positions can be determined to encourage the detection of all appropriate segment points. From the examples shown in FIG. 4, if the expanding direction of a scanning circle is perpendicular to the sketching track, the segment points usually will not be missed. Therefore multiple scanning circles can be used to encourage the detection of all appropriate segment points.

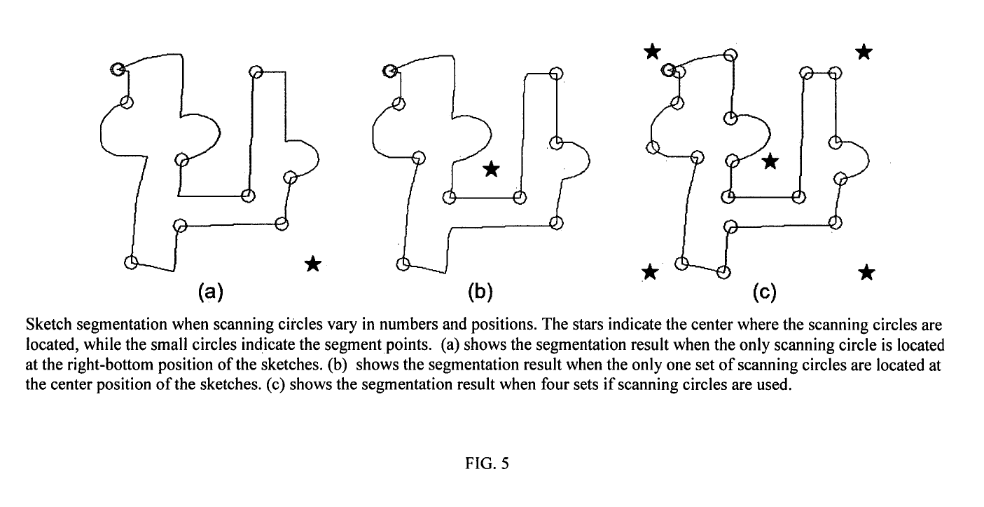

FIG. 5 shows the segmentation results when the scanning circles vary in numbers and positions. The stars in FIG. 5 indicate the centers where the scanning circles are located, while the small circles indicate the segment points. It can be seen that in some configurations of scanning points, some segment points may be missed when only one origin point of the scanning circle is used. When multiple origin points of scanning circles are used to scan the sketches, more segment points can be detected.

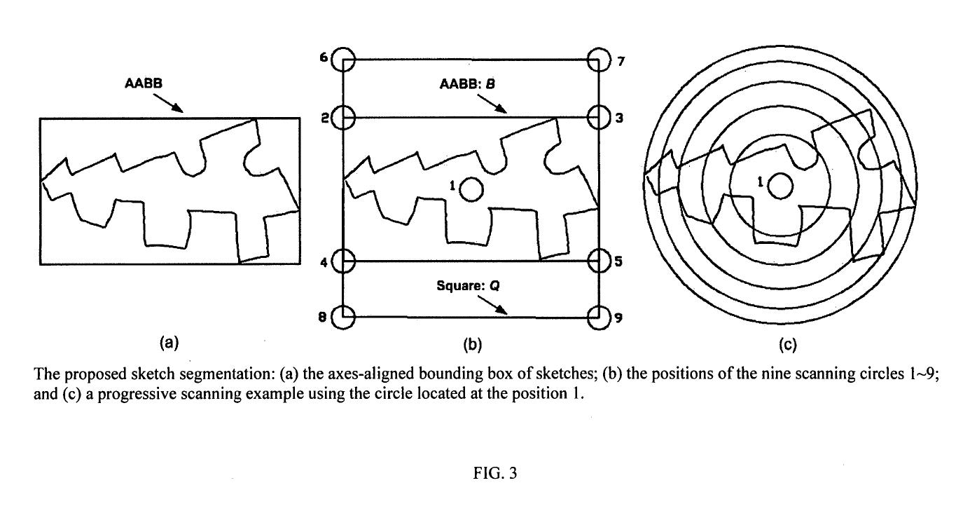

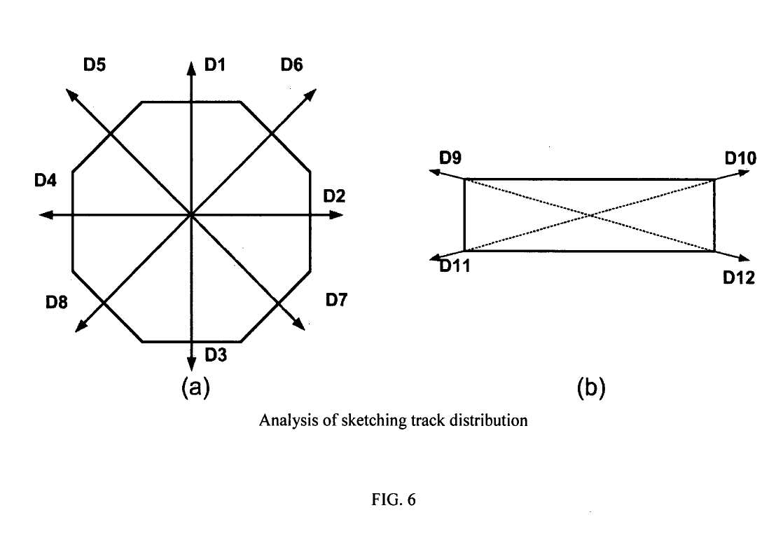

If more sets of scanning circles at different positions are used, the possibility of missing segment points will be lower. However, a heavier computational load may be the result since a lot of intersection operations are involved in the scanning process. Also, more false-positive segment points may be detected when the scanning step is too small. By analyzing possible sketching tracks, nine positions can be selected. The nine positions are largely distributed around eight major directions, as FIG. 6(a) shows. As FIG. 3(b) shows, Circle 1 is responsible for four directions, i.e., D1-D4, while Circle 6-Circle 9, located at the corners of the bounding square, are responsible for another two directions, i.e., D5-D6. To assure that segment points along elongated sketches can be detected, circles located at the four corners of the bounding box as FIG. 6(b) shows can also be used. To improve the chances of a scanning circle intersecting with all line segments, the radius of a scanning circle can be big enough to enclose the sketch. Therefore, the respective diagonal length of the box can be selected as its radius for the purpose of simplicity.

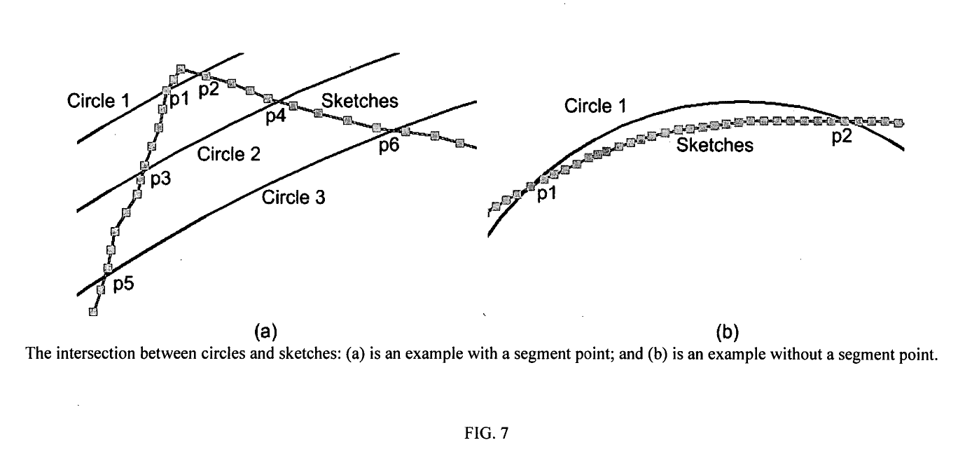

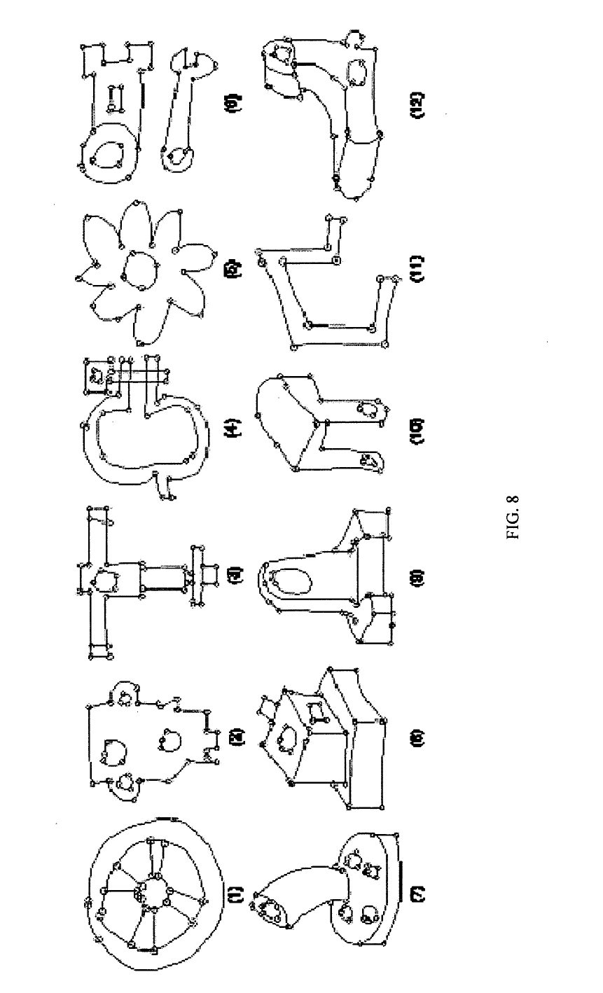

When a circle scans a sketch, the radius of the circle can be changed progressively from a predefined value to zero (or from zero to a predefined value). This process can result in a series of intersection points between the circle and the sketch. As Equation (1) shows, the sketch consists of a sequence of small segments; thus, the scanning process computes the intersection between line segments and circles with the same center but different radii. FIG. 7 shows the local enlargement of freehand sketches in which Circle 1, Circle 2, and Circle 3 have the same centers but different radii. The intersection points between the sketch and Circle 1-Circle 3 are p1-p6 respectively.

For the example shown in FIG. 7(a), p3, p4, p5, and p6 are not segment points owing to the better selection of candidates p1 and p2. Similarly, for another case shown in FIG. 7(b), p1 and p2 are not segment points because the sketch is not apparently composed of multiple primitives. By examining multiple intersecting cases, segment points can be located within the consecutive intersected points that are close enough to each other. For example, the distance between p1 and p2 in FIG. 7(a) is less than the distances between p3 and p4, and p5 and p6. Similarly, the distance between p1 and p2 in FIG. 7(b) is large enough that there are too many line segments between them. Therefore, a distance-based rule can be used to determine segment points: if the number of the line segments between two consecutive intersected points is less than a small range εₙ, then the two intersected points will be the possible candidates of segment points. The small value εₙ depends on the resolution (or density) of the sketch. A higher resolution suggests more line segments are within the same distance of the sketch. In some applications the resolution can be controlled within a certain range by setting the smallest line segment, i.e., Min{length((xᵢ,yᵢ),(xᵢ₊₁,yᵢ₊₁))|0≦i≦n}>ξ, where ξ is a small Euclidean distance. For example, ξ can be 0.05, and ε can be 2. In practice, users can adjust the two parameters according to the current sketching resolution.

Generally, the complexity of the sketches is proportional to the number of line segments contained in the sketches. More complex sketches usually have more segment points. To find all segment points, it can be necessary to use a series of circles with a small step in increasing radii to scan the sketch. However, a too small step implies additional unnecessary segments points that have to be filtered out. Experiments can be used to achieve a balance between the segmentation accuracy and the computational load. Computation time can be roughly linear to the step number of a scanning operation.

Due to the symmetry property of their positions, the nine predefined scanning circles can be classified into three categories: (1) circles located at the center of the bounding box, such as Circle 1 in FIG. 3; (2) circles located at the corners of the bounding box, such as Circle 2-Circle 5 in FIG. 2; and (3) circles located at the corners of the bounding square, such as Circle 6-Circle 9. Also, the first seven sketched drawings (i.e., 1-7) are selected in FIG. 8 and they have different complexities. The number of line segments ranges from 47 to 327.

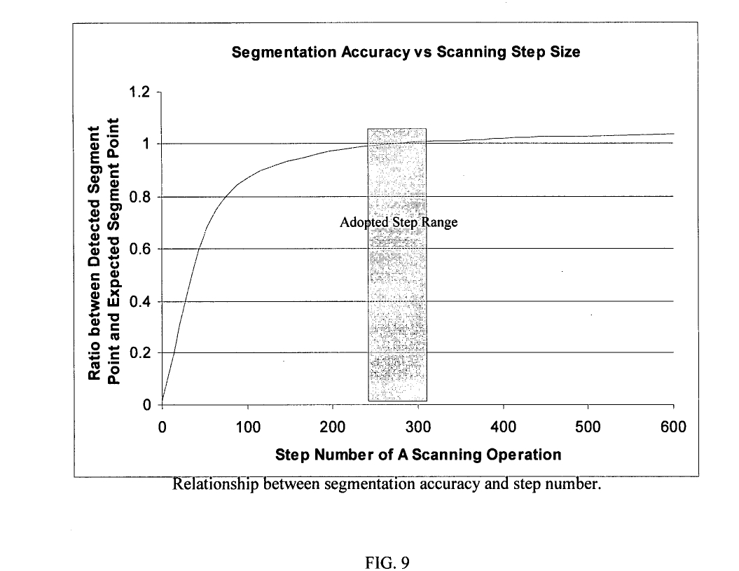

FIG. 9 shows the relationship between segmentation accuracy and scanning step size. The horizontal axes represent the step number of one scanning operation, while the vertical axes represent the ratio between the numbers of the detected segment points and all true segment points contained in the sketch. Since some points are incorrectly detected as segment points which can be denoted “False Positive” segment points, the ratio between the numbers of the detected segment points and all true segment points is larger than 1. Such false positive segment points generally occur when the step length is too small. The desired balance between the computational load and segmentation accuracy is the number of scanning operations where the ratio becomes 1. For the category of scanning circles located at the center of the bounding box, the ratio between the step number and the line segment number of the sketches with different complexity falls within the range 0.9˜1.1. For simplicity, the number of line segments can be chosen as the step number. The same can process can be repeated for the other scanning circle locations.

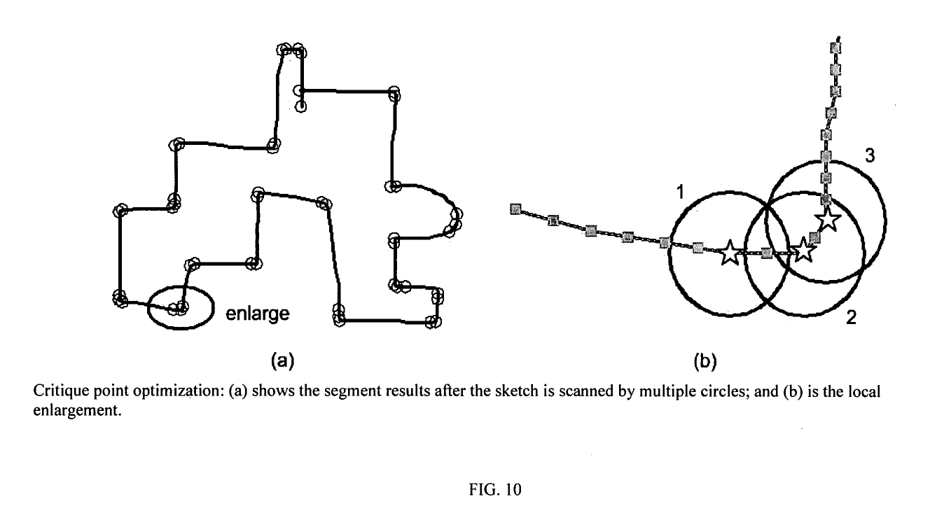

As seen in FIG. 5, segment point clusters can be formed when multiple circles are used to scan freehand sketches. FIG. 10(a) shows another segmentation cluster example, while FIG. 10(b) shows the local enlargement of the segmentation result in FIG. 10(a). When the sketch resolution is high enough, as the marked local area in FIG. 10(a) shows, human eyes sometimes cannot differentiate the borders between consecutive line segments. The three stars and circles in FIG. 10(b) indicate the positions of the three segment points respectively. For each segment point cluster, only one point need be selected. To choose an appropriate segment point, a strategy can be used by which the point that is located on the region with the largest curvature is retained. For example, in FIG. 10(b), point 2 has a larger curvature than the other points. By checking each cluster according to this strategy, a unique segment point can be obtained.

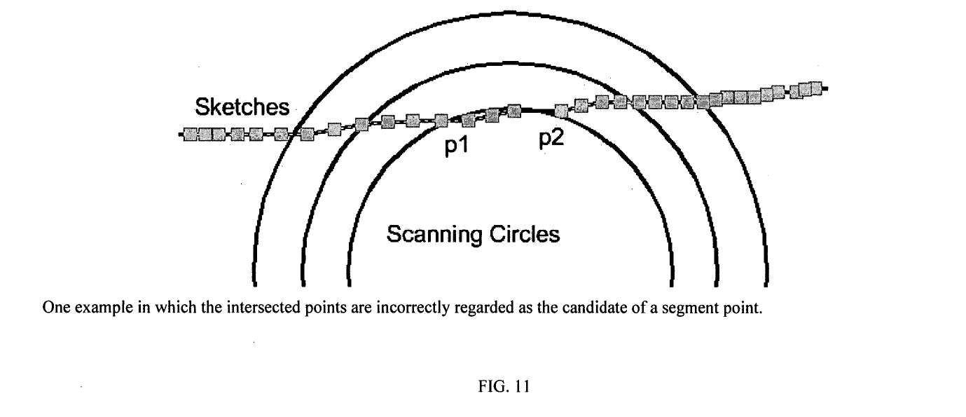

FIG. 11 shows a case where a point might be incorrectly detected as a segment point. This example shows that two consecutive intersected points might satisfy the segment point condition when the circle series is scanning a sketch which tends to be a straight line. To discard this false segment point, the angle formed by two consecutive line segments may be checked. If the angle is larger than certain value α_{θ}, then the two points can be discarded. In one implementation, α_{θ} can be selected as 170 degrees. In fact, the radius of the scanning circle is large compared to the length of the line segment of freehand sketches. Therefore, such intersected points can be discarded according to this rule.

In experiments testing the methods disclosed herein, based on 63 sketched drawings, the final results are summarized in Table 1, while the detailed statistics are listed in the Appendix. It can be seen that the overall accuracy of the segmentation is 92.5%. Accuracy may be further improved when combined with other methods.

TABLE 1
Sketch Segmentation

| | | False | False | | |
|---|---|---|---|---|---|
| | True Positive | Positive | Negative | Total | Accuracy |
| Segment Point | 1033 | 72 | 12 | 1117 | 92.5% |

Geometric Primitive Recognition

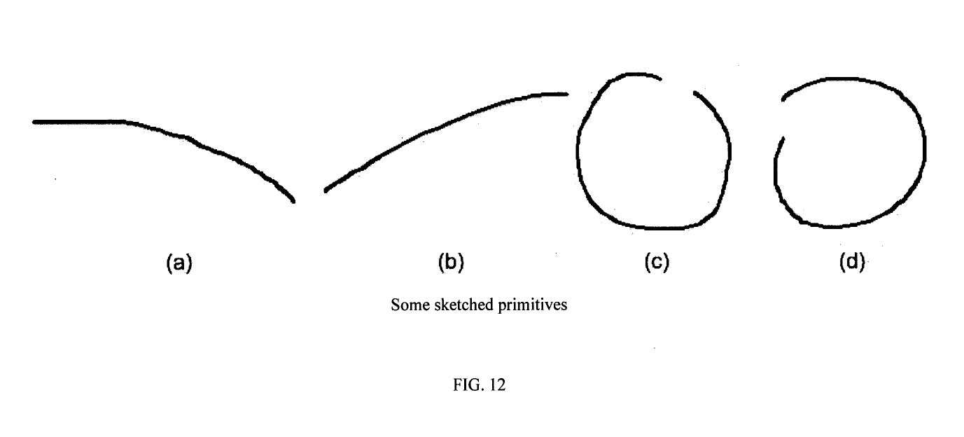

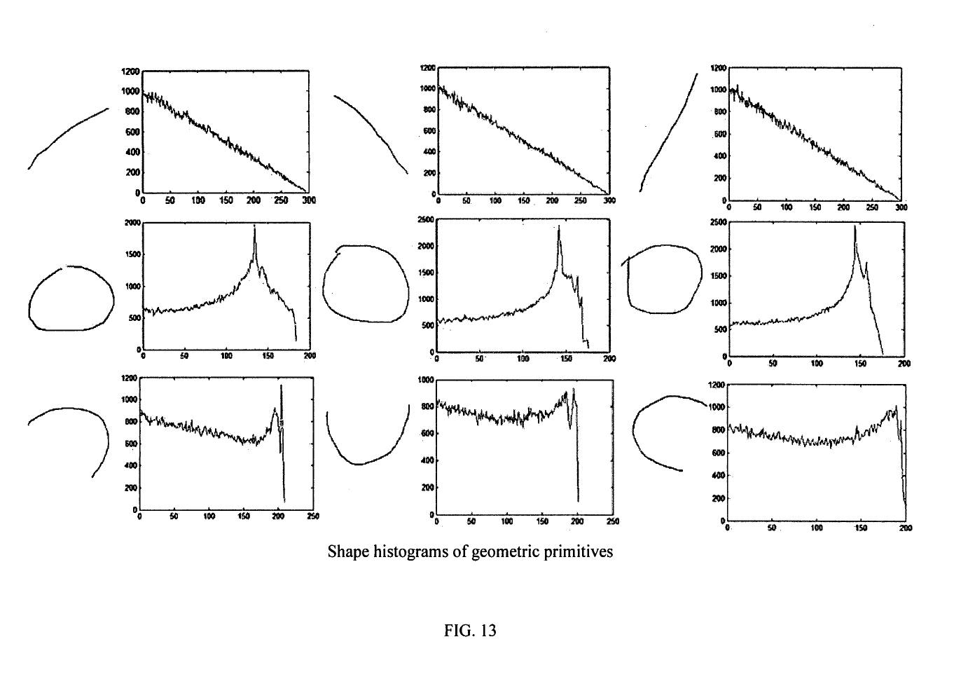

Lines, circles, and arcs can be the most popular primitives when users sketch their ideas using a pen. Although there may be only three kinds of geometric primitives, it is still not easy to robustly recognize them because there may be no clear boundary between them in many cases. As the examples in FIG. 12 show, it is hard to assert whether (a) and (b) are lines or arcs, or (c) and (d) are circles or arcs. From these examples, differences can be seen between a line and a circle. Also, an arc can be wrongly recognized as either a line or a circle. In fact, the three primitives can be generalized as some type of arc. A line is an arc with an infinite radius and a circle is an arc with a 360 degree angle. Using this observation, a shape descriptor called 2D shape histogram can be used to differentiate these primitives.

A shape histogram method, similar to that disclosed in U.S. patent application Ser. No. 11/288,911 entitled METHODS FOR RETRIEVING SHAPES AND DRAWINGS, can be used to recognize independent strokes representing geometric primitives. Experiments show this derivation is good at recognizing geometric primitives and is independent of stroke-order, -number, and -direction, as well as invariant to rotation, scaling, and translation of strokes.

This step uses a series of points to approximate a 2D shape. To ensure that the sampling process can be conducted efficiently and uniformly, a look-up-table-based approach can be used.

For example, one step may be to compute the summed length of all line segments included in the freehand sketch. When each line segment is added, the summed length is saved into table T with size n, where n−1 is the total number of the line segments. Table T can be represented by a linear array as Equation (4) shows.

$$T = \{ {t}_{i} \text{\vert} {t}_{i} = {\sum }_{j = 0}^{i} L ( ( {x}_{j} , {y}_{j} ) , ( {x}_{j + 1} , {y}_{j + 1} ) ) , 0 \leq i \leq n - 1 \} \qquad ( 4 )$$

where L is the Euclidean distance between two points.

Another step may be to generate a random real number r between 0 and the total length tₙ₋ₗ, and then use the well-known binary-search algorithm to find out the position m where r is located in the table. The found position corresponds to the line segment ((xₘ,yₘ),(xₘ₊₁,yₘ₊₁)).

A further step may be to generate a random real number l between 0 and 1. According to Equation (5), a sample point (xₖ,yₖ) can be determined and saved into an array A.

$$\{ \begin{matrix}{x}_{k} = {x}_{m} + l ⨯ ( {x}_{m + 1} - {x}_{m} ) \\ {y}_{k} = {y}_{m} + l ⨯ ( {y}_{m + 1} - {y}_{m} )\end{matrix} \qquad ( 5 )$$

Repeating those two generating steps for 2×n times, n point pairs can be obtained that are sampled in an unbiased manner.

In the sampling procedure, sampling density can be considered. From the perspective of statistics, more samples imply a more precise approximation of the original shape. A basic criterion that can be used is ensuring that sampling points are uniformly distributed on all critical shape components of the sketch. Experiments regarding the tradeoff between efficiency and precision have showed that 10⁵ sampling point pairs can achieve a better balance between precision and computational efficiency for any given 2D legacy drawing.

Once enough random point pairs are sampled, the next step is to build the corresponding distance histogram which is described by a shape function. The Euclidean distance between two points can be selected as the shape function. Given n point pairs, their distances are calculated. Then by traversing each point pair (xᵢ,yᵢ),(xᵢ₊₁,yᵢ₊₁) in an array A and counting the number of sample pairs that fall into a certain distance range, a shape histogram H can be built. If the whole distance range is divided uniformly by N parts, then a shape histogram H is represented as

$$\{ \begin{matrix}H ( k ) += 1 \\ k = \frac{Euclidean ( ( {x}_{i} , {y}_{i} ) , ( {x}_{i + 1} , {y}_{i + 1} ) )}{N}\end{matrix} , \\ 0 \leq i \leq 2 n - 1 , 1 \leq k \leq N \qquad ( 6 )$$

where Euclidean is the straight line distance between two points.

Since strokes drawn at different times can have different geometric sizes, a normalization process is needed to account for this difference. A standard value L can be determined and used for normalization. Generally, there can be two simple ways for normalization as shown in Equation (7). The first one uses the maximum distance among all sampled point pairs as the standard value. The second one uses the average distance of all sample point pairs as the standard value.

$$L = \{ \begin{matrix}Max \{ Euclidean ( ( {x}_{i} , {y}_{i} ) , ( {x}_{i + 1} , {y}_{i + 1} ) ) \} \\ \frac{{\sum }_{i = 0}^{n - 1} Euclidean ( ( {x}_{i} , {y}_{i} ) , ( {x}_{i + 1} , {y}_{i + 1} ) )}{n}\end{matrix} \\ 0 \leq i \leq n - 1 \qquad ( 7 )$$

FIG. 13 shows the shape histograms of some primitive shapes. For the lines, circles, or arcs, their shape histograms are similar despite their lengths, directions, or shapes. From these examples, several conclusions can be reached: (1) different geometric primitives have different 2D shape histograms; (2) a freehand stroke of a geometric primitive has a stable shape histogram; and (3) shape histogram is independent of stroke-order, -number, and -direction, as well as invariant to rotation, scaling, and translation of strokes. These conclusions build the basis of geometric primitive recognition.

The problem of recognizing a primitive shape can now be transformed to computing the similarity between two histograms. Minkowski distance Lₙ is used in one embodiment. The similarity σ of two histograms, H1 and H2, can be computed using Equation (8).

$$σ ( {H}_{1} , {H}_{2} ) = \sqrt[n]{{\sum }_{i = 0}^{N} {\vert {H}_{1} ( i ) - {H}_{2} ( i ) \vert}^{n}} \qquad ( 8 )$$

where N is the dividing number of a histogram. For the two histograms, the smaller W means more similarity. To determine the primitive shape that a sketch represents, corresponding templates can be predefined. Because the shape histogram of a sketch is a perturbed version of the corresponding regular shape, the histogram of a regular shape as a template can be selected.

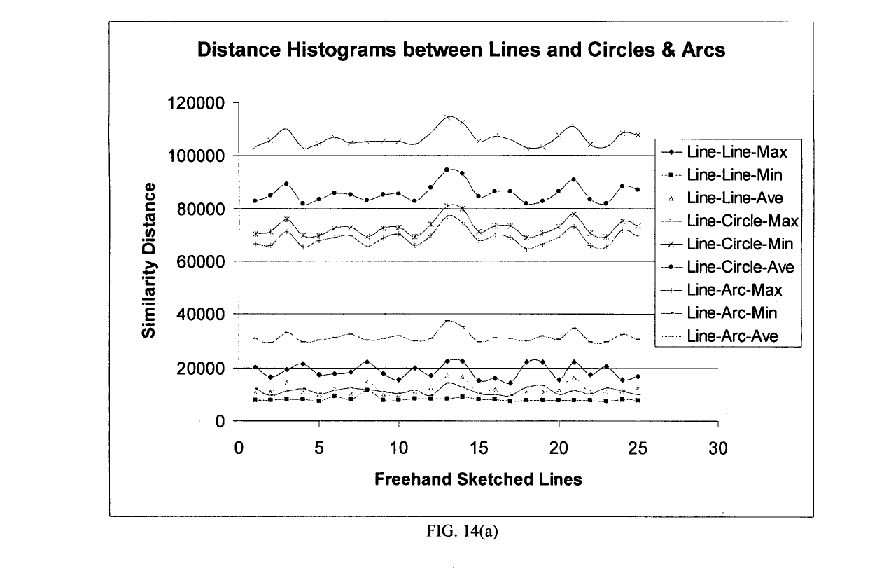

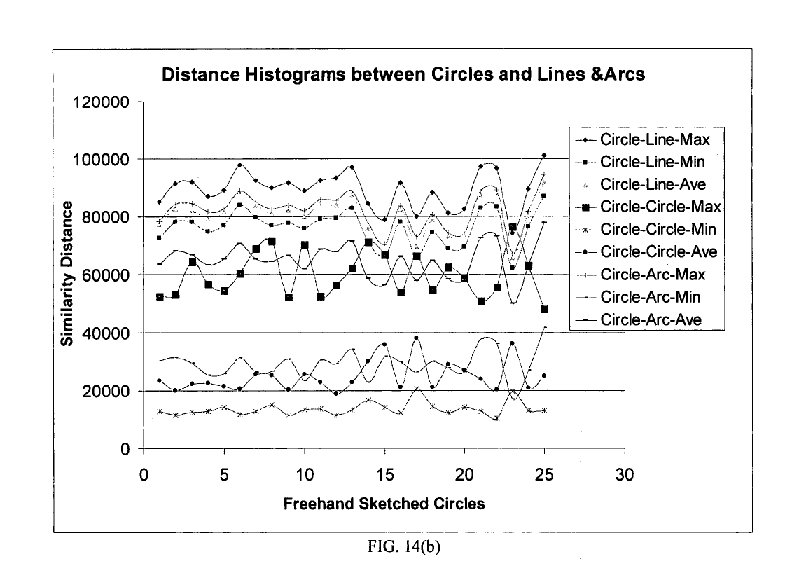

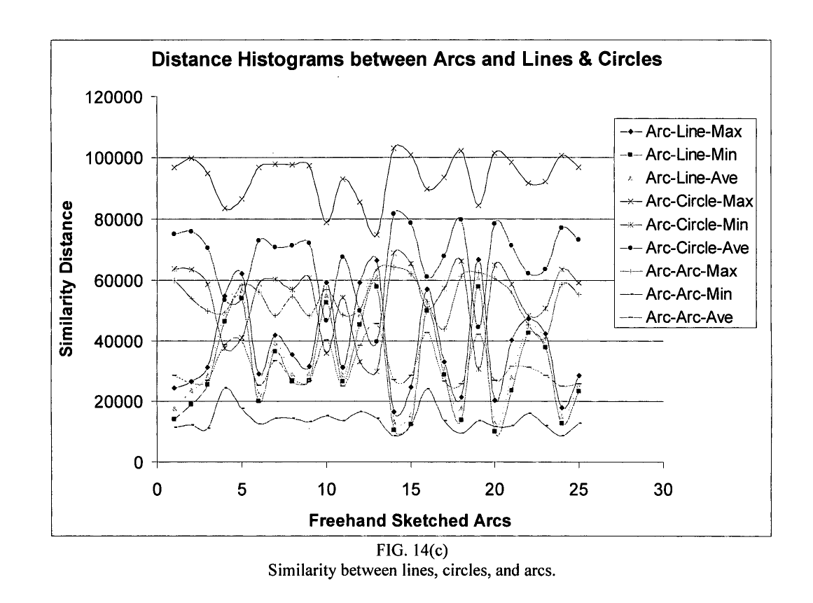

An experiment was conducted to check whether a 2D shape histogram can robustly recognize geometric primitives. Eight users were chosen to freely sketch lines, circles, and arcs. Each primitive was sketched ten times with different sizes and different shapes. All the sketches were indexed as templates. Then each user was asked to input sketches freely and evaluate the recognition performance. Three kinds of distances are considered: (a) the maximum distance, (b) the minimum distance, and (c) the average distance. The similarity distance between the later input sketches and the templates is shown in FIG. 14. Each curve is noted in FIG. 14 according to a naming convention using a format of “**-&&-##”. “**”, which denotes the input sketches; “&&”, which denotes the template sketches; and “##”, which denotes the type of similarity distance.

FIG. 14(a) shows the similarity results when the sketched inputs are lines. When users sketch a line, it can be differentiated by computing its similarity with the templates. FIG. 14(b) shows the similarity results when the sketched inputs are circles. For most cases, it can be determined that the sketched shapes are circles. However, sometimes a circle is misrecognized as an arc since there are intersections between some of the curves. FIG. 14(c) shows the similarity results when the sketched inputs are arcs. For most cases, it can be determined that the sketched shapes are arcs. However, sometimes an arc is misrecognized as a circle since there are intersections between some of the curves. From these experiments, it may be concluded that simple distance computation does not assure good recognition accuracy.

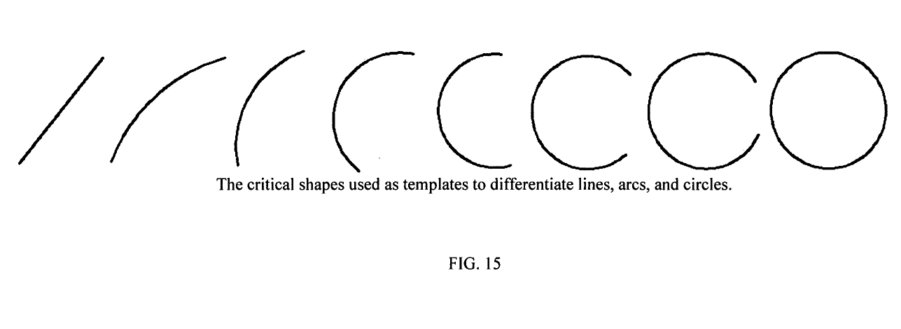

To improve the recognition performance, the similarity between the input sketches can be compared using a set of critical templates. The critical shape acts as a “boundary shape.” Since an arc is generally confused with a line and circle, the extremes correspond to line and circle. Therefore, some critical arc shapes, a line, and a circle can be defined. FIG. 15 shows the critical shapes. Due to the fact that the 2D shape histogram is transformation invariant, the shape histograms of regular lines or circles are the same. FIG. 15 shows an example range of critical shapes. With the help of these critical shapes, curvature or angle criterion is avoided to differentiate the primitives.

On the basis of the beautification of the 63 sketched drawings, the primitive recognition described above has been evaluated and summarized in Table 3. Additional information can be found in the Appendix. Totally, there are 1074 primitives, among which the correct recognitions are 1062 and the false recognitions are 12. Once the freehand sketches are segmented, most of the primitives can be recognized successfully.

TABLE 3
Primitive Recognition

| | True | False | | |
|---|---|---|---|---|
| | Recognition | Recognition | Total | Accuracy |
| Primitive | 1062 | 12 | 1074 | 98.9% |
| Recognition | | | | |

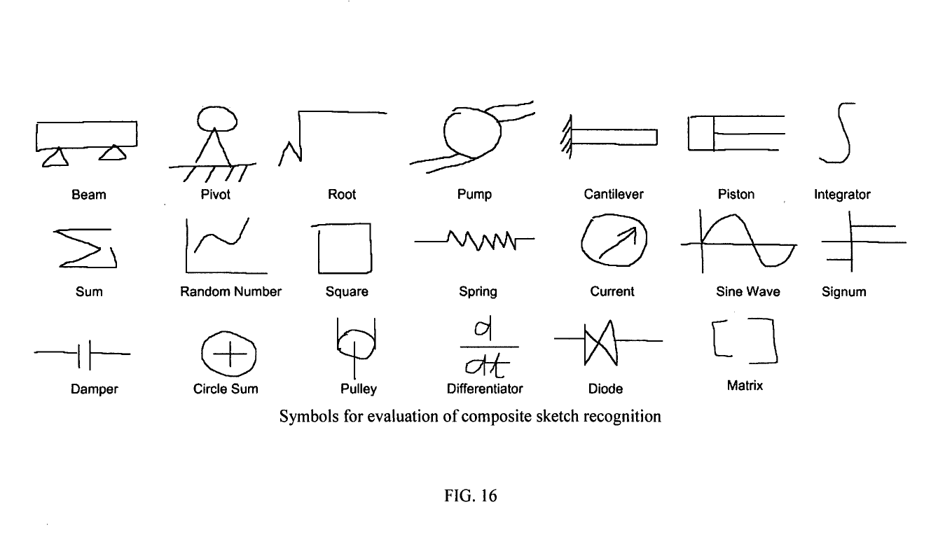

As mentioned above, the 2D shape histogram method can also be used to recognize composite sketches. To asses the performance of composite sketch recognition, a set of symbols as shown in FIG. 16 can be used. These symbols were indexed with regular shapes as the basis of shape similarity computation and recorded in a database. Given a sketched query, its similarity can be computed with all the pre-indexed symbols and then all the symbols can be output according to their similarity. Five users were asked to sketch each symbol twice and check the order in which the desired shape occurs in the rank list. All the retrieval tasks were completed in real time. The experimental results are presented in Table 4. In the tests, most of the symbols were retrieved as the first order of the rank list except four simple symbols “Root”, “Integrator,” “Square” and “Matrix”. The symbols “Root”, “Integrator”, “Square” and “Matrix” were usually misplaced if a user's sketched input was not good. If the desired symbols are located in the first order of the rank list, methods described above can achieve an overall accuracy 92%. The accuracies can reach to 96% and 99% respectively when the desired symbols are located within the first three of the rank list.

TABLE 4
Composite sketch recognition

| | Located within | Located within | Located within |
|---|---|---|---|
| Subject | Top 1 | Top 2 | Top 3 |
| 1 | 38 | 39 | 40 |
| 2 | 37 | 40 | 40 |
| 3 | 37 | 38 | 39 |
| 4 | 37 | 38 | 40 |
| 5 | 35 | 37 | 39 |
| Average | 92% | 96% | 99% |
| Accuracy | | | |

A larger database was used to test the retrieval performance of the method disclosed above. It contained 2000 legacy drawings from industrial fields. Nine related methods were compared and the results were presented in the form of Precise-Recall Curves. The experiment shows that the 2D shape histogram has the second best performance compared to the other 8 methods. The best one is the 2.5D spherical harmonics transform method. The reason that the 2.5D spherical harmonics method was not used to compute the similarity between freehand sketches is due to the fact that the method requires a bounding box of the sketches. For similar sketches such as lines, arcs and circles, the respective bounding box may vary greatly, thus leading to a poor performance. From the experiment it was determined that the estimated accuracy rate of the 2D shape retrieval of our prototype system is within 75˜80%.

Sketch Beautification

Once the primitives in the sketches have been recognized, the primitives can be beautified by assigning proper parameters. For a line, a starting point and an ending point are needed. A simple way is using the starting and ending points of the sketch segment as the initial starting and ending points of a line. For an arc or circle, three points on the sketches are selected to compute the radius and the center of the arc or circle because the three points determine an arc or circle uniquely. The three points are composed by the two ending points and the middle point of the parsed segments.

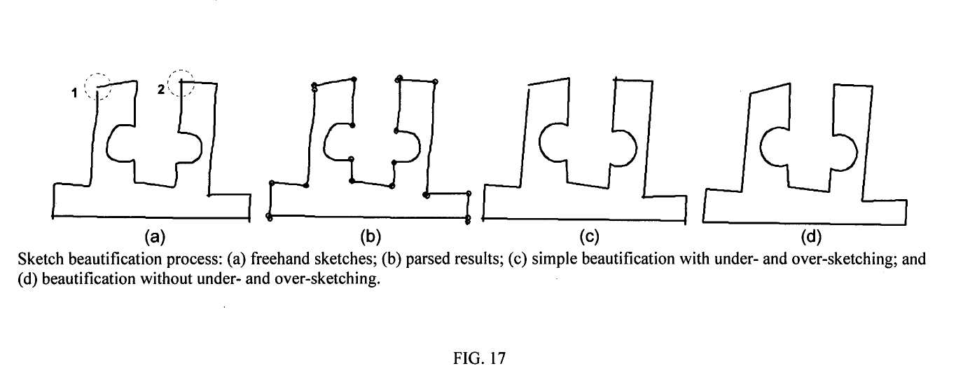

It can be sometimes difficult for users to draw any graph precisely during the sketching process. Under- and over-sketching sometimes occur during the sketching process. In FIG. 17(a), the region marked by “1” is under-sketched, while the region marked by “2” is over-sketched. Just simply converting the segments into the corresponding regular primitives may not be enough to improve the appearance of a sketch. FIG. 17(c) is the simple beautification of the sketches in FIG. 17(a). However, it is not a good beautification because the under- and over-sketching have not been corrected. In one embodiment, an assumption can be made that users normally start and end their sketches at a geometric entity. In this way, the nearest-neighbor principle can be used to handle under- and over-sketching issues: find the nearest primitive that the starting point or the ending point of a sketch locates, and the intersecting point between the two primitives is the right starting or ending point. FIG. 17(d) is the beautification after the under- and over-sketching is processed. In another embodiment, when over- and under-sketching happen, the start and end points can be adjusted respectively.

There is, however, no need to immediately repair any over-sketching or under-sketching that may be present in a sketch. The reparation can be done by incorporating the over-sketching or under-sketching into a constraint system described below. Once the geometric constraint system is solved, the reparation will be finished automatically.

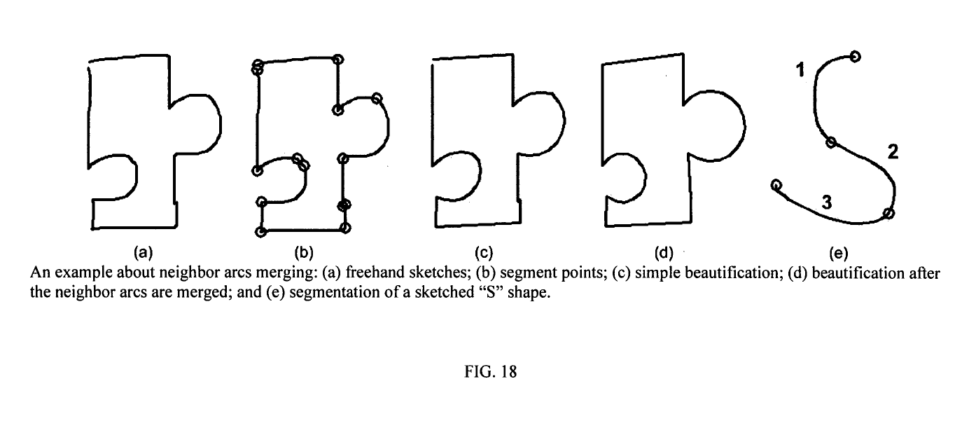

Turning now to the beautification of arcs, since variations of sketched arcs can be large, sometimes the proposed segment method might parse a sketched arc into several parts. FIG. 18(b) shows such an example in which one arc is parsed into three segments, while the other arc is segmented into two segments. From a visual appearance, the two groups of segments constitute two independent arcs. An approach can be used to merge certain arcs. Given two consecutive arcs, they will be merged as one arc if two conditions are satisfied: (a) they have the same angle direction; and (b) the difference between their angles at the connected point is within a small range. For example, in FIG. 18(e), the directions of segment “1” and segment “2” are different, while the directions of segment “2” and segment “3” are the same. Therefore, we can merge segment “2” and segment “3” as the same arc. FIG. 18(c) shows the beautification result of FIG. 18(a) without merging the neighbor arcs, while FIG. 18(d) shows the beautification result after the neighbor arcs are merged.

Implied Geometric Constraint Detection

The beautification described above transforms the freehand sketches into the corresponding regular geometric shapes but does not necessarily consider some intentions implied in a user's sketch. For example, the beautification described above does not explicitly consider certain geometric constraints such as perpendicular and parallel properties between shapes. These constraints represent the relationships between primitives. The geometric constraints can be classified into two categories: explicit constraints and implicit constraints. Explicit constraints refer to the constraint that users specify explicitly, while implicit constraints mean some implied constraints that users do not specify directly. With implicit constraints, users will express their ideas more naturally and efficiency will be improved at the same time. It can be natural for some users to express such intentions implicitly when they are sketching. For example, when a user sketches the shape as shown in FIG. 18(a), it is possible that there are perpendicular or parallel constraints between two neighboring line segments. Therefore, some applications of beautification should take the implied constraints into account. This constraint-based beautification can provide designers more flexibility than traditional interaction paradigms. With implicit constraints, users can express their ideas more naturally, and the efficiency will be improved at the same time. An algorithm can be used to detect the implicit constraints and beautify the sketches with the help of a constraint satisfaction solver. The popular implicit constraint types are summarized in Table 1. Below we describe the detection of the constraints implied in a user's sketch.

TABLE 1
Some popular implicit constraints

| | Line | Circle | Arc |
|---|---|---|---|
| Line | (1) Parallel | (1) Tangent | (1) Tangent |
| | (2) Perpendicular | (2) Co-Center | |
| Circle | (1) Tangent | (1) Tangent | (1) Tangent |
| | | (2) Co-Center | (2) Co-Center |
| Arc | (1) Tangent | (1) Tangent | (1) Tangent |
| | | (2) Co-Center | (2) Co-Center |

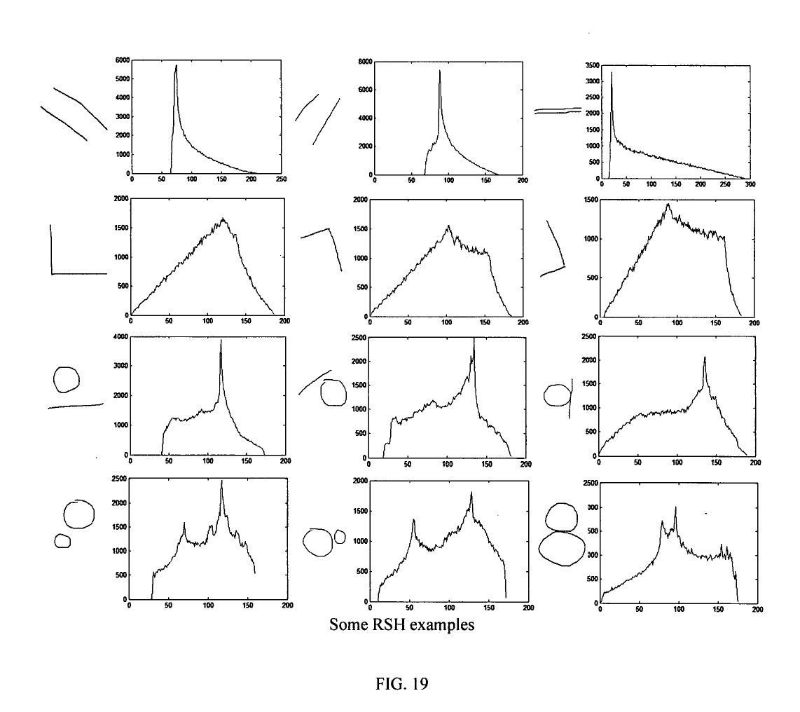

To detect implicit constraints, a method dubbed Relative Shape Histogram (RSH) can be used to check the relationship between two geometric primitives. RSH is similar to the shape histogram method described in U.S. patent application Ser. No. 11/288,911 entitled METHODS FOR RETRIEVING SHAPES AND DRAWINGS. RSH has similar sketch representation, sampling strategy, and shape function as the shape histogram method. One difference is that RSH only considers the Euclidean distances between point pairs that are sampled from different primitives; i.e., (xᵢ,yᵢ) and (xᵢ₊₁,yᵢ₊₁) in Equation (6) are located on different primitives. According to the basic steps of the FIG. 19, some RSHs between sketched primitives with certain constraints are shown. From these histograms, some conclusions can be drawn: (1) sketches representing the same kind of constraint have similar RSHs; (2) sketches representing different constraints have different RSHs; and (3) the RSH of a constraint is independent of stroke-order, -number, and -direction, as well as invariant to rotation, scaling, and translation of strokes.

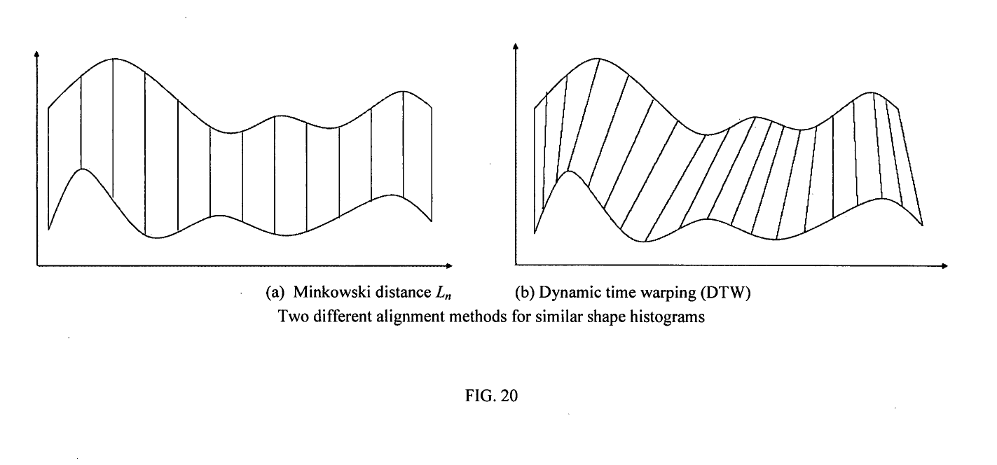

Furthermore, two interesting phenomena from the RSHs can be noticed. The first one is that certain parameters can be estimated from the respective RSH. For example, some examples of parallel constraint are shown in the first row of FIG. 19. Along the horizontal axes, there is a certain distance between the origin and the RSH curve. In fact, this distance corresponds to the distance between the two lines. The same conclusion also holds for the constraints shown in the third and fourth rows. The second phenomenon is that the RSHs of the same constraints have similar distributions of peaks and troughs. Thus, the histograms of the same constraints have approximately the same overall component shapes. However, these shape components do not line up along the horizontal axis. As FIG. 20(a) shows, Minkowski distance may not be good at computing the similarity between two RSHs because it does not build an intuitive alignment between RSHs. In order to find the similarity between such sequences, a “warp” operation, such as that presented below, is needed to achieve an intuitive alignment.

A dynamic time warping (DTW) approach can be used to compute the similarity between sketches and existing templates and thus determine the constraint type of the RSH. DTW was originally developed to align two spectral sequences of speech and is now being widely used in speech processing, bio-informatics, and hand-writing recognition. FIG. 20(b) shows such an alignment by DTW.

Suppose there are two time series S and T with length m and n respectively:
S={s₁,s₁, . . . ,sₘ}, T={t₁,t₁, . . . ,tₙ} (9)
To align S and T, we need to construct an m×n matrix M whose element at position (i,j) is the distance D between the two points sᵢ and tⱼ. In this way, matrix element (i,j) corresponds to the alignment between the points sᵢ and tⱼ. Now the alignment problem can be converted to finding a warping path that represents the correspondence between the two sequences S and T. In particular, DTW is defined as the warping path that minimizes the warping cost, which can be calculated by a dynamic programming approach as:

$$D ( i , j ) = min \{ \begin{matrix}D ( i , j - 1 ) \\ D ( i - 1 , j ) \\ D ( i - 1 , j - 1 )\end{matrix} \} + d ( {s}_{i} , {t}_{j} ) \qquad ( 10 )$$

According to the DTW theory, the following steps are summarized to determine the constraint type of an RSH:
(1) Determine a set of templates as standard sequences for each constraint type. The aim is to determine as many constraints as possible that designers use to improve accuracy.
(2) Exclude certain constraint types by checking the distance between the origin and an RSH. For example, if the distance is larger than a predefined tolerance ε, such as the first RSH in the third row of FIG. 19, then it can be concluded that the line and the circle are not tangential to each other at all.
(3) Move the histogram of an RSH along the horizontal axes to ensure that the first point s₁ or t₁ is located at the origin.
(4) Compute the DTW warping path between an RSH and a template, and the template with the minimum warping cost represents the desired constraint type. For simplicity, Euclidean distance can be used to compute the distance between two points.

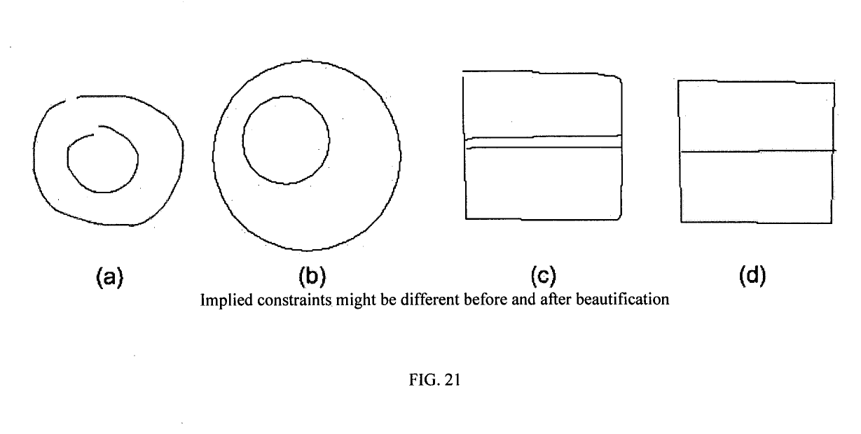

In most research work about GCSS (Geometric Constraint Satisfaction System) [37-39], implicit constraints are widely mentioned. However, no literature is found to handle the implicit constraints implied in freehand sketches. Despite the fact that GCSS also uses the same word “sketch”, the referred “sketch” is not a freehand sketch but a regular sketch. The most popular way to determine the type of implicit constraint is computing the distance between the parameters of the primitives. For example, the parallelism between two lines can be determined by checking the angle difference between the two lines is small enough. However, it is difficult to use this intuitive method to check the constraint type between sketched primitives. In FIG. 21, two examples are shown to explain this issue. The sketches in FIG. 21(a) express two circles with the same center, while FIG. 21(b) shows the beautified results. However, because the parameters (i.e., center and radius) of each circle are determined separately, there might be a big difference after the beautification operation, which could lead to a conclusion that there is not any relationship between the two circles. A similar example is shown in FIG. 21(c). After the beautification, the two lines across the square become the same line because their end points are close enough. Therefore, a more stable method is to check their constraint type directly on the basis of the original freehand sketches instead of the final beautified results.

Among the 63 sketched drawings, 20 drawings were used to assess the performance of implicit constraint detection. Given two segmented primitives, four kinds of constraints are checked, including parallelism, concentricity, perpendicularity and tangency. The results are presented in Table 5.

TABLE 5
Implicit Constraint Detection

| Constraint Type | | | |
|---|---|---|---|
| Parallelism | Co-center | Perpendicular | Tangent |

| | | | | |
|---|---|---|---|---|
| True Positive | 57 | 22 | 78 | 17 |
| False Positive | 14 | 6 | 19 | 4 |
| False Negative | 0 | 0 | 0 | 0 |
| Total | 71 | 28 | 97 | 21 |
| Accuracy (%) | 80.3% | 78.6% | 80.4% | 80.9% |

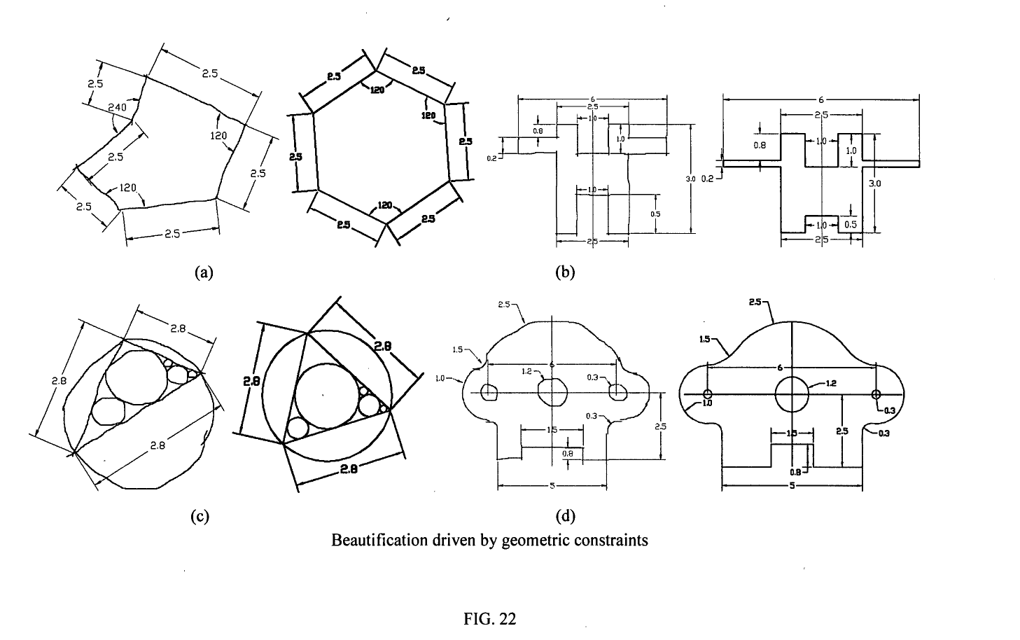

In one embodiment, once the sketches are beautified, a geometric constraint system can be formed with the help of implicit and explicit constraints. In another embodiment, a constraint solver can be used to further beautify the sketches by satisfying the geometric constraints. Some examples about beautification driven by constraints are presented in FIG. 22. In still other embodiments, the constraint-based beautification process can be performed interactively. Since may not be easy to recognize dimensions, traditional dimensions can be used to impose explicit constraints.

Detection of Falsely Identified Segment Points

In some embodiments, after a beautification process has been completed based on the identified segment points, the following process can revise some points that may have been falsely identified. The following disclosure describes the process of how to discover the region of interest (ROI) and correct some segmentation point inaccuracies.

First, denote the result obtained from the preliminary beautification as
P={P₁, . . . P_{N}},Pᵢ={pₛ,pₑ,s₁, . . . sₘ} (11)
where i=1, . . . N. N is the number of primitives after beautification, pₛ,pₑ are two end points of Pᵢ, s₁, . . . sₘ are segments in Pᵢ after beautification, and m is the number of segments in Pᵢ.

By locating the start and end points of Pᵢ in the original sketch, the original segments between the two end points can be identified. Denote the segments between the end points as Sᵢ={pₛ,pₑ,seg₁, . . . seg_{K}} where, K is the number of segments in this portion of the original sketch In addition, denote the connecting segment from pₛ to pₑ as H=(pₛ,pₑ).

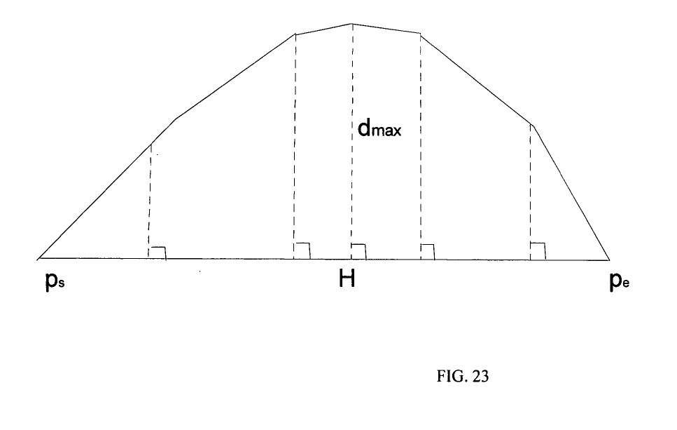

The maximum deviation dₘₐₓ can be defined as the maximum perpendicular distance from the end of each segment to H as it is shown in FIG. 23.

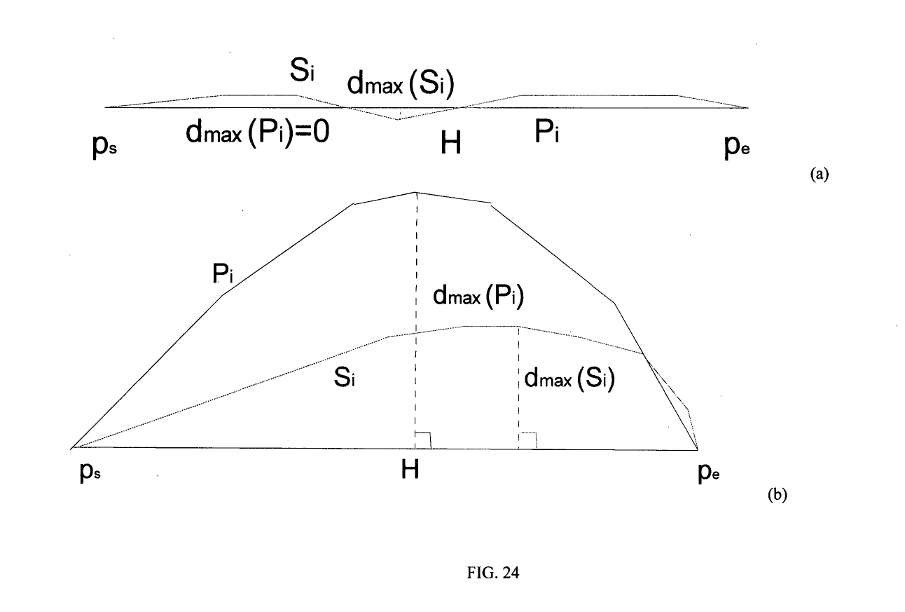

By comparing the difference between dₘₐₓ(Pᵢ) and dₘₐₓ(Sᵢ), a determination of whether there are any bogus primitives can be made. For example, if |dₘₐₓ(Pᵢ)−dₘₐₓ(Sᵢ)|≦ξ, such as in FIG. 24(a), then the system has identified the critical points and the correct primitive. If |dₘₐₓ(Pᵢ)−dₘₐₓ(Sᵢ)|>ξ such as FIG. 24(b) then this can be identified as a false primitive.

If a false primitive has been identified, the following method can be used in some applications to correct the false identification. The fact that noise and regular strokes coexist in a sketch makes the critical point detection different from the existing corner detection methods that are used for continuous curves. The values of slopes and curvatures may become oscillated along the discrete strokes in a single entity when noise strokes are encountered. Thus they are not optimal for this case.

In this algorithm, a divide and conquer strategy is employed. Points with dₘₐₓ(Sᵢ)>ξ are required to be located first. In reality, there are two cases where the points with the maximum deviation in Sᵢ may exist.

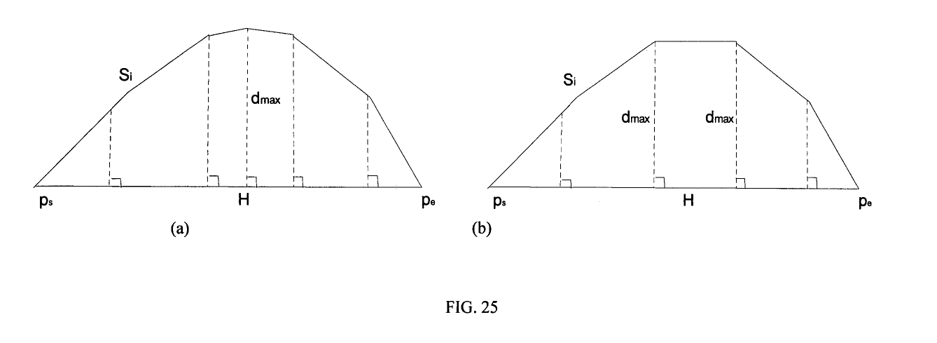

When there are only an odd number of points with the maximum distance, the medium one of them is selected. FIG. 25(a) shows a special although most commonly seen case. When there is an even number of points with the maximum deviation, any of the medium one can be selected as FIG. 25(b) shows a case where two end points share the same maximum deviation.

After the point where dₘₐₓ(Sᵢ)>ξ is located, the original set of segments Sᵢ={pₛ,pₑ,segₗ, . . . segₖ} is split by this point and become two set of segments Sᵢ₁={pₛ,p_{new1},segₗ, . . . segₖ} and Sᵢ₂={p_{new},Pₑ,segₖ₊₁, . . . seg_{K}}. This algorithm then finds the points where dₘₐₓ(Sᵢ₁)>ξ and dₘₐₓ(Sᵢ₂)>ξ are located and splits the segments by the points. The algorithm handles recursively within each segment until the value of dₘₐₓ for each one is less than the threshold.

Each set of segments after this decomposition process can be denoted as D={D₁, . . . D_{N′}},Dᵢ={p′ₛ,p′ₑ,s′₁, . . . s′ₘ}. One procedure to decide the geometric property of Dᵢ is to again check the value of dₘₐₓ (Dᵢ) even though dₘₐₓ(Dᵢ)≦ξ for stopping condition. If dₘₐₓ(Dᵢ)≦ a much smaller threshold, then Dᵢ is determined as a straight line, else Dᵢ is a curve.

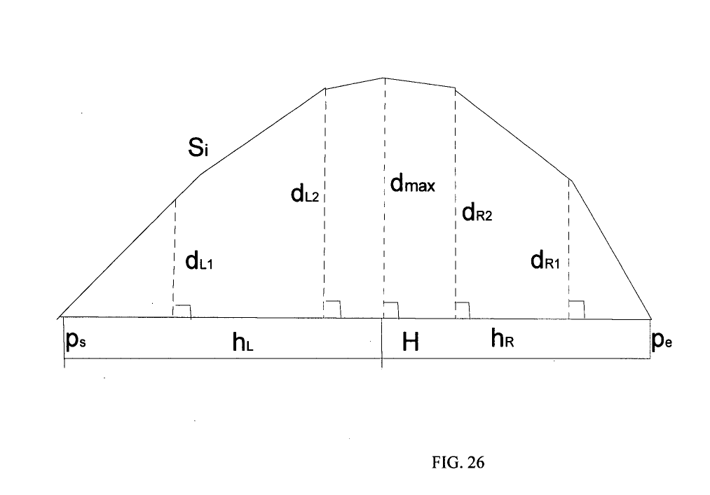

Referring now to FIG. 26, the following process will remove false critical points and merge the segments into appropriate primitives.
1) In case where two neighboring sets of segments are straight lines, calculate the angle α between them. If α> threshold, then merge the two segments into one by connecting the start point of the first segment and the end of the other segment.
2) In a case where two neighboring sets of segment are curves, use the following conditions to check if the segments should be merged:
   |h_{L}−h_{R}≦threshold
   |Average(d_{L1}+d_{L2}+ . . . )−Average(d_{R1}+d_{R2}+ . . . )|≦threshold
where h is the horizontal distance from the end point to the projected point with the maximum deviation, and d is the distance from a sketch point to the line drawn between the end points. Segments are merged if the above conditions are met. The merge process checks each neighboring set of segments until there is no neighboring pair that satisfies the above conditions.

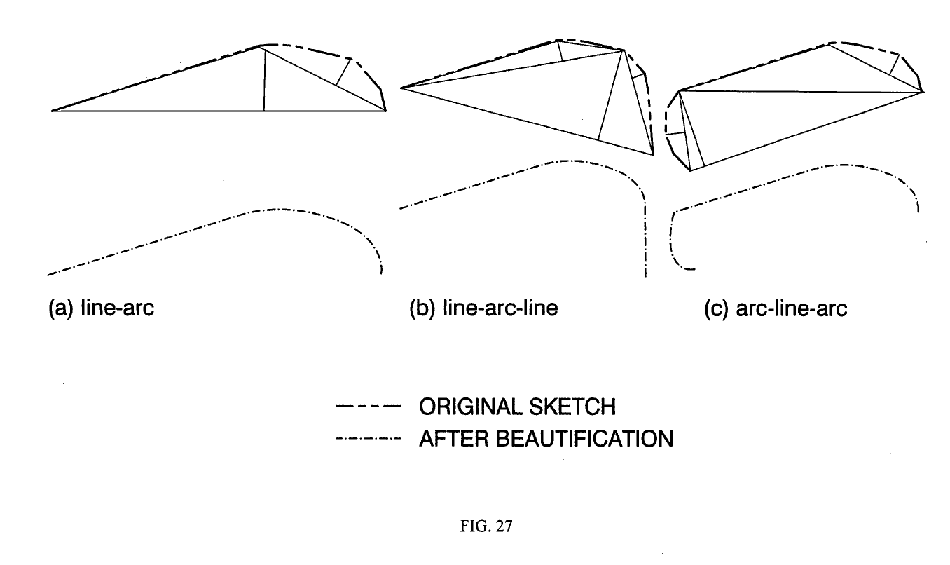

Referring now to FIG. 27, the following examples illustrate the expected result of using this method to solve some typical line arc combination cases.

Some Examples of Freehand Sketch Parameterization

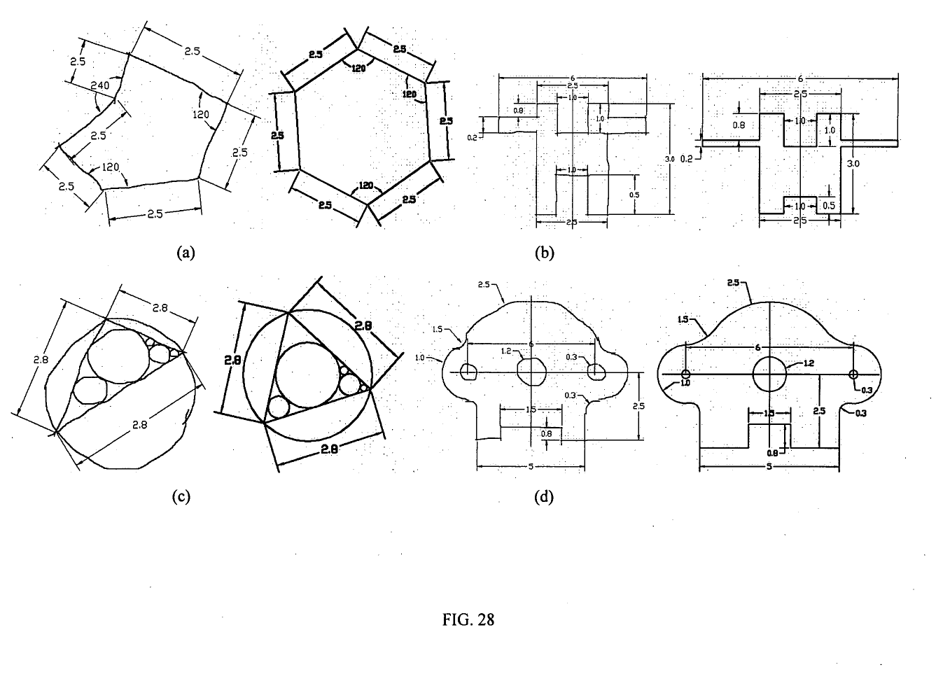

To demonstrate the validity of the methods disclosed herein, some examples are presented in FIG. 28. When these drawings are finished and the constraints are imposed, they will be regularized automatically. It can be seen that the design quality, naturalness, and efficiency are improved with the help of freehand sketch parameterization. In the example shown in FIG. 28(c), the implied tangent constraints are detected automatically and users have no need to specify them explicitly. In FIG. 28(b) and FIG. 28(d), the middle lines act as mirror constraint indicators which implies that the corresponding drawings are symmetrical along these lines. In this way, the symmetrical primitives along the respective middle line are detected within a certain tolerance. In particular, the geometric constraint satisfaction module has been tested against a standard library, which consists of more than 100 hundred different standard drawings from the CAD domain. The experiment shows that our proposed geometric constraint solver can drive all these drawings correctly and efficiently.

Thus, as described above a user can enter and beautify a sketch using the methods disclosed. A user sketch can be segmented into individual geometric primitives. The individual primitives can then be beautified. In addition to geometric primitives, implied geometric constraints, such as parallel lines, can be detected and beautified. After beautification of geometric primitives, or of implicit geometric constraints, or both, the beautified sketch can be processed to determine if any segments points were falsely identified. If so, the sketch can be beautified once again in the same manner disclosed above discarding the falsely identified segment points.

After beautification, the sketch can be used in a variety of forms. The beautified sketch can be used to search in a database of known objects similar to the beautified sketch using methods disclosed in U.S. patent application Ser. No. 11/288,911, filed Nov. 29, 2005 entitled: METHODS FOR RETRIEVING SHAPES AND DRAWINGS. Alternatively, a sketch may be beautified, a search conducted for a similar shape in a library of known symbols, and the sketch can be replaced with a symbol that approximates the sketch. Such would be beneficial in applications such as circuit analysis software wherein a user can supply a sketch of a desired element such as a resistor, the sketch can be beautified and compared against a library of symbols and then replaced with an analysis object of the corresponding shape.

Referring back generally to FIG. 1, one embodiment of such a system is schematically indicated. At box 100 a user supplies a sketch. The sketch can be entered using a stylus or any other device suitable to convey a users sketching direction and desires into computerized form. The user sketch is then scanned at box 110 using techniques described above to segregate the sketch into segments composed of geometric primitives such as, but not limited to, circles and lines. At box 120 the segments are then processed to detect the type of geometric entity. Such processing can be accomplished by, among others, shape histogram methods described above. Switch 130 permits the system to either continue beautifying the sketch or to verify the segmentation performed at box 110. Box 140 verifies the segmentation by determining if the segmentation at box 110 was non-desirable. If so then box 140 can re-segment the primitives and return the sketch to box 120. Box 150 detects implicit constraints such as, but not limited to, parallel lines using techniques described above. After implicit constraints have been detected the sketch can be further beautified. Switch 160 permits the system to either continue beautifying the sketch or to verify the segmentation performed at box 110. Box 170 verifies the segmentation by determining if the segmentation at box 110 was non-desirable. If so then box 170 can re-segment the primitives and return the sketch to box 120 for further beautification. Indicated generally at 180, once beautified the sketch can be useful in a number of applications such as, but not limited to input for a drawing search application such as that disclosed in U.S. patent application Ser. No. 11/288,911, filed Nov. 29, 2005, entitled METHODS FOR RETRIEVING SHAPES AND DRAWINGS.

The embodiment shown in FIG. 1 can be used in a variety of forms such as computer workstation. The embodiment could also be integrated into a web based application such as where a user in a remote location can input a sketch using, for example, a stylus, and then upload the sketch to another computer for beautification. The beautified sketch could be returned to the user's location, or alternatively, could be further used to search for a model in a model library. The beautified sketch could also be relayed to other computers for further use. Such would be the case in a collaborative design environment where users are geographically distributed. In this situation a sketch could be input by one user, shared with others either before or after beautification, and then the beautified sketch could be used to search a model database.

In other embodiments, the beautified sketch could also be further processed using explicit geometric constraints. In this situation a user may provide a sketch and additionally impose explicit geometric constraints such as, for example, assigning lengths to certain features of the sketch. The system could then satisfy these constraints and return the results to the user. A beautified drawing which satisfies explicit constraints could then be used, as described above, in other applications such as input useful in searching a database of drawings.

Thus, methods have been disclosed to beautify freehand sketches, such as sketch segmentation, geometric shape recognition, implicit constraint detection, and beautification. These are achieved using scanning circles at key locations, shape histogram matching, relative shape histograms, and finally, constraint satisfaction. In some embodiments, the beautification not only transforms the parsed segments into the regular primitives but also satisfies the implicit constraints implied in the sketch and the explicit constraints imposed by the user. The proposed methods have some valuable advantages, such as transformation-invariance, stroke-speed, and curvature independence. The beautification methods disclosed herein may be useful in computer-aided design, which is expected to provide users with great flexibility, high efficiency, and naturalness in product design. In some applications users may express constraints directly with freehand sketches. In addition, the proposed method may be extended to 3D for modeling purposes.

Herein, an approach supporting freehand sketch parameterization is introduced, including freehand sketch recognition, implicit constraint detection, and a geometric constraint solver. This proposed method allows users to sketch freehand drawings and regularize them automatically according to the imposed geometric constraints. The whole parameterization process is independent of stroke-order, -number, and -direction, as well as invariant to rotation, scaling, and translation of strokes. In particular, with the help of an interface-open and -reconstruction strategy, the described graph reasoning method can provide an analytical solution for most geometric constraint satisfaction problems. Experiments show that this interaction paradigm supported by freehand sketch parameterization can provide users with a great flexibility, high efficiency and naturalness.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

| | | APPENDIX | | | | | | | | | |
|---|---|---|---|---|---|---|---|---|---|---|---|
| | | Sketches | | | | | | | | | |
| | | NO. 1 | NO. 2 | NO. 3 | NO. 4 | NO. 5 | NO. 6 | NO. 7 | NO. 8 | NO. 9 | NO. 10 |
| Sketch | TP | 10 | 10 | 17 | 18 | 5 | 17 | 11 | 16 | 28 | 24 |
| Segmentation | FP | 0 | 0 | 0 | 1 | 0 | 1 | 1 | 2 | 1 | 1 |
| | FN | 0 | 0 | 0 | 0 | 0 | 0 | 1 | 0 | 1 | 0 |
| | Total | 10 | 10 | 17 | 19 | 5 | 18 | 13 | 18 | 30 | 25 |
| | Accuracy | 100 | 100 | 100 | 94.7 | 100 | 94.4 | 84.6 | 88.9 | 93.3 | 96 |
| Primitive | TR | 10 | 10 | 16 | 19 | 5 | 18 | 13 | 17 | 31 | 25 |
| Recognize | FR | 0 | 0 | 0 | 0 | 0 | 0 | 1 | 0 | 0 | 0 |
| | Total | 10 | 10 | 16 | 19 | 5 | 18 | 14 | 17 | 31 | 25 |
| | Accuracy | 100 | 100 | 100 | 100 | 100 | 100 | 92.9 | 100 | 100 | 100 |
| | | Sketches | | | | | | | | | |
| | | NO. 11 | NO. 12 | NO. 13 | NO. 14 | NO. 15 | NO. 16 | NO. 17 | NO. 18 | NO. 19 | NO. 20 |
| Sketch | TP | 32 | 32 | 24 | 20 | 10 | 6 | 16 | 26 | 11 | 37 |
| Segmentation | FP | 3 | 2 | 1 | 0 | 0 | 1 | 2 | 4 | 2 | 4 |
| | FN | 1 | 0 | 0 | 0 | 0 | 0 | 1 | 0 | 0 | 1 |
| | Total | 36 | 34 | 25 | 20 | 10 | 7 | 19 | 30 | 13 | 42 |
| | Accuracy | 88.9 | 94.1 | 96 | 100 | 100 | 85.7 | 84.2 | 86.7 | 84.6 | 88.1 |
| Primitive | TR | 28 | 33 | 25 | 20 | 12 | 7 | 17 | 29 | 12 | 40 |
| Recognize | FR | 1 | 0 | 0 | 0 | 0 | 0 | 1 | 0 | 0 | 0 |
| | Total | 29 | 33 | 25 | 20 | 12 | 7 | 18 | 29 | 12 | 40 |
| | Accuracy | 96.6 | 100 | 100 | 100 | 100 | 100 | 94.4 | 100 | 100 | 100 |
| | | Sketches | | | | | | | | | |
| | | NO. 21 | NO. 22 | NO. 23 | NO. 24 | NO. 25 | NO. 26 | NO. 27 | NO. 28 | NO. 29 | NO. 30 |
| Sketch | TP | 24 | 21 | 24 | 11 | 18 | 8 | 15 | 12 | 28 | 24 |
| Segmentation | FP | 0 | 0 | 3 | 0 | 3 | 0 | 3 | 2 | 2 | 7 |
| | FN | 0 | 0 | 1 | 0 | 0 | 0 | 0 | 0 | 1 | 0 |
| | Total | 24 | 21 | 28 | 11 | 21 | 8 | 18 | 14 | 31 | 31 |
| | Accuracy | 100 | 100 | 85.7 | 100 | 85.7 | 100 | 83.3 | 85.7 | 90.3 | 77.4 |
| Primitive | TR | 22 | 19 | 26 | 14 | 21 | 10 | 19 | 13 | 28 | 32 |
| Recognize | FR | 0 | 0 | 1 | 0 | 0 | 0 | 1 | 0 | 1 | 0 |
| | Total | 22 | 19 | 27 | 14 | 21 | 10 | 20 | 13 | 29 | 32 |
| | Accuracy | 100 | 100 | 96.3 | 100 | 100 | 100 | 95 | 100 | 96.6 | 100 |
| | | Sketches | | | | | | | | | |
| | | NO. 31 | NO. 32 | NO. 33 | NO. 34 | NO. 35 | NO. 36 | NO. 37 | NO. 38 | NO. 39 | NO. 40 |
| Sketch | TP | 23 | 14 | 9 | 14 | 13 | 12 | 8 | 21 | 13 | 14 |
| Segmentation | FP | 1 | 1 | 1 | 0 | 0 | 0 | 0 | 1 | 0 | 0 |
| | FN | 0 | 0 | 1 | 0 | 0 | 0 | 0 | 0 | 0 | 1 |
| | Total | 24 | 15 | 11 | 14 | 13 | 12 | 8 | 22 | 13 | 15 |
| | Accuracy | 95.8 | 93.3 | 81.8 | 100 | 100 | 100 | 100 | 95.5 | 100 | 93.3 |
| Primitive | TR | 23 | 13 | 10 | 18 | 12 | 13 | 8 | 17 | 12 | 13 |
| Recognize | FR | 0 | 0 | 0 | 0 | 0 | 0 | 0 | 0 | 0 | 1 |
| | Total | 23 | 13 | 10 | 18 | 12 | 13 | 8 | 17 | 12 | 14 |
| | Accuracy | 100 | 100 | 100 | 100 | 100 | 100 | 100 | 100 | 100 | 92.9 |
| | | Sketches | | | | | | | | | |
| | | NO. 41 | NO. 42 | NO. 43 | NO. 44 | NO. 45 | NO. 46 | NO. 47 | NO. 48 | NO. 49 | NO. 50 |
| Sketch | TP | 19 | 12 | 23 | 25 | 27 | 15 | 14 | 12 | 6 | 15 |
| Segmentation | FP | 0 | 0 | 0 | 0 | 0 | 2 | 1 | 0 | 0 | 0 |
| | FN | 1 | 0 | 0 | 0 | 0 | 0 | 0 | 1 | 0 | 0 |
| | Total | 20 | 12 | 23 | 25 | 27 | 17 | 15 | 13 | 6 | 15 |
| | Accuracy | 95 | 100 | 100 | 100 | 100 | 88.2 | 93.3 | 92.3 | 100 | 100 |
| Primitive | TR | 16 | 12 | 16 | 19 | 22 | 16 | 15 | 12 | 6 | 14 |
| Recognize | FR | 0 | 0 | 0 | 0 | 0 | 1 | 0 | 1 | 0 | 0 |
| | Total | 17 | 12 | 16 | 19 | 22 | 17 | 15 | 13 | 6 | 14 |
| | Accuracy | 94.1 | 100 | 100 | 100 | 100 | 94.1 | 100 | 92.3 | 100 | 100 |
| | | Sketches | | | | | | | | | |
| | | NO. 51 | NO. 52 | NO. 53 | NO. 54 | NO. 55 | NO. 56 | NO. 57 | NO. 58 | NO. 59 | NO. 60 |
| Sketch | TP | 13 | 6 | 16 | 18 | 28 | 14 | 10 | 10 | 22 | 15 |
| Segmentation | FP | 1 | 0 | 2 | 2 | 2 | 0 | 1 | 1 | 5 | 0 |
| | FN | 0 | 0 | 0 | 0 | 0 | 0 | 0 | 0 | 0 | 0 |
| | Total | 14 | 6 | 18 | 20 | 30 | 14 | 11 | 11 | 27 | 15 |
| | Accuracy | 92.9 | 100 | 88.9 | 90 | 93.3 | 100 | 90.9 | 90.9 | 81.5 | 100 |
| Primitive | TR | 14 | 5 | 17 | 20 | 29 | 14 | 13 | 11 | 27 | 13 |
| Recognize | FR | 0 | 0 | 0 | 0 | 0 | 0 | 0 | 0 | 0 | 0 |
| | Total | 14 | 5 | 17 | 20 | 29 | 14 | 13 | 11 | 27 | 13 |
| | Accuracy | 100 | 100 | 100 | 100 | 100 | 100 | 100 | 100 | 100 | 100 |

| | | Sketches | | |
|---|---|---|---|---|
| | | NO. 61 | NO. 62 | NO. 63 |
| Sketch | TP | 20 | 22 | 19 |
| Segmentation | FP | 2 | 2 | 2 |
| | FN | 1 | 0 | 0 |
| | Total | 23 | 24 | 21 |
| | Accuracy | 86.9 | 91.7 | 90.5 |
| Primitive | TR | 22 | 23 | 21 |
| Recognize | FR | 1 | 0 | 1 |
| | Total | 23 | 23 | 22 |
| | Accuracy | 95.7 | 100 | 95.5 |

What is claimed is:

1. A method of segmenting a computer-based sketch drawing, the sketch drawing represented by points or primitives, comprising:
providing a line drawing having line segments;
providing a plurality of scanning circles;
determining the intersection points of at least one scanning circle with the line drawing; and
setting a segment point based on the intersection points.

2. The method of claim 1, further comprising:
determining an axis-aligned bounding box enclosing the line drawing;
determining a bounding square enclosing the line drawing;
wherein the corners of the axis-aligned bounding box and the corners of the bounding square are used to locate scanning circles; and
providing multiple scanning circles centered the corners of the axis-aligned bounding box and the corners of the bounding square.

3. The method of claim 2, further comprising:
changing the radius of at least one scanning circle from a first radius to a second radius.

4. The method of claim 3, further comprising:
setting a minimum radius value; and
setting a maximum radius value equal to the diagonal length of the axis-aligned bounding box.

5. The method of claim 1, wherein setting a segment point includes:
selecting a point between the intersection points; and
setting a segment point equal to the point between the intersection points.

6. The method of claim 1, wherein selecting the point between the intersection points comprises:
selecting a segment number value;
counting the segments between intersection points to create a total segment number; and
setting candidate segment points equal to the intersection points when the total segment number is less than the segment number value.

7. The method of claim 6, wherein setting candidate segment points includes:
discounting candidate segment points when the angle formed by two consecutive segments exceeds a predefined value.

8. A method of using exemplar shapes between a primitive shape and a drawn shape, the method comprising:
choosing a first primitive shape and a second primitive shape;
selecting a series of critical shapes between the first primitive shape and the second primitive shape;
computing a distance histogram of the first primitive shape, the second primitive shape, and the intermediate shapes;
providing a user sketch;
selecting a primitive from the user sketch
computing a distance histogram of the primitive from the user sketch; and
comparing the distance histograms of the first primitive shape, the second primitive shape, and the intermediate shapes with the distance histogram of the primitive from the user sketch.

9. A method to beautify drawings, the method comprising:
providing a user sketch;
converting elements of the user sketch to geometric primitives; and
altering inadequate intersections of the geometric primitives.

10. The method of claim 9 wherein altering the inadequate intersections of geometric primitives includes:
searching for an over-sketch;
correcting the over-sketch;
searching for an under-sketch; and
correcting the under-sketch.

11. The method of claim 10 wherein correcting the over-sketch includes:
determining the intersection of two primitives; and
setting the end points of the primitives closest to the intersection point to be equal to the intersection point.

12. The method of claim 10 wherein correcting the under-sketch includes:
selecting a first point of a first entity;
finding a first point of a second entity closest to the first point of the first entity;
extending the first entity in the direction of the first entity and the second entity in the direction of the second entity until both entities intersect.

13. A method of merging geometric primitives in a computer memory comprising:
providing a first arc and a second arc, the arcs being consecutive;
merging the two arcs at a connected point into a single arc when the arcs have the same angle direction and the difference between the angles at the connected point satisfies a predefined value.

14. A method of determining an implicit geometric constraint in a sketch, the method comprising:
selecting a first and a second primitives from the sketch containing more than two primitives; and
calculating a shape histogram considering only the first and second primitives.

15. A method of comparing two shape histograms, the method comprising:
computing a shape histogram considering only a first and a second primitive to create a relative shape histogram;
computing a shape histogram of a predefined set of constraint types to create a constraint types relative shape histograms; and
comparing the relative shape histogram with the constraint types relative shape histograms.

16. The method of claim 14 wherein the comparing the relative shape histogram with the constraint type relative shape histogram includes:
computing a dynamic time warping path between the relative shape histogram and the constraint types relative shape histograms; and
selecting a constraint type from the set of constraint types having the minimum warping cost.

17. A method of verifying sketch segmentation, the method comprising:
providing a user sketch;
segmenting the user sketch;
selecting a geometric primitive from the segmented user sketch, the geometric primitive having a first start point and a first end point;
beautifying the geometric primitive thereby creating a revised geometric primitive having a second start point and an second end point;
drawing a reference line between the second start point and the second end point;
selecting a candidate geometric primitive when the absolute value of the maximum distance of the geometric primitive minus the maximum distance of the revised geometric primitive exceeds a critical value;
selecting a split point on the candidate geometric primitive where the absolute value of the maximum distance of the geometric primitive minus the maximum distance of the revised geometric primitive exceeds a critical value;
splitting the geometric primitive into a first candidate segment having a first candidate segment start point and a first candidate segment end point and a second candidate segment at the split point having a second candidate segment start point and a second candidate segment end point;
drawing a first candidate segment line between the first candidate segment start point and a first candidate segment end point;
determining the first candidate segment maximum distance of the first candidate segment from the first candidate segment line; and
categorizing the first candidate segment as a line if the first candidate segment maximum distance falls below a categorization value.

18. The method of 17 further comprising:
drawing a second candidate segment line between the second candidate segment start point and a second candidate segment end point;
determining the second candidate segment maximum distance of the second candidate segment from the second candidate segment line; and
categorizing the second candidate segment as a line if the second candidate segment maximum distance falls below a categorization value.

19. The method of 18 further comprising:
determining the angle between the first candidate segment point and the second candidate segment point if the first candidate segment is categorized as a line and the second candidate segment is categorized as a line; and
merging the first candidate segment point and the second candidate segment point if the angle is less than an angle critical value.

20. A method of using a sketch beautification system, the method comprising:
providing a user sketch;
segmenting the user sketch into initial geometric primitives;
recognizing the initial geometric primitives;
beautifying the initial geometric primitives to create first geometric primitives;
verifying the segmentation;
recognizing implicit geometric constraints in the first geometric primitives; beautifying the first geometric primitives to create second geometric primitives;
verifying the segmentation of the second geometric primitives to create second geometric primitives; and
using the second geometric primitives in a drawing search.
